(19) United States
(12) Patent Application Publication
(10) Pub. No.: US 2023/0259925 A1
(43) Pub. Date: Aug. 17, 2023

(54) System and Method for Conducting Payment and Business Transactions

(71) Applicant: Jianqing Wu, Beltsville, MD (US)

(72) Inventor: Jianqing Wu, Beltsville, MD (US)

(21) Appl. No.: 17/671,073

(22) Filed: Feb. 14, 2022

(51) Int. Cl. G06Q 20/38; G06Q 20/40; G06F 3/04842; G06F 3/0482

(52) U.S. Cl. CPC G06Q 20/3829; G06Q 20/401; G06F 3/04842; G06F 3/0482; G06Q 2220/00

(57) ABSTRACT

A system and method for conducting business transactions with improved user data storage security. Business transactions are scheduled on a user computer such as a cellular phone or a desktop. In conducting a business transaction at the user computer, the user provides an encryption key and causes the user computer or a connected server to decrypt user's data that has been previously stored on the user computer or a server to produce usable data. The server then uses the usable data to complete the intended business transaction. Scheduled business transactions on the user computer include making recurring payments, issuing digital check, making inaudible payment over an active voice connection, managing credit and medical records, conducting multiple-party business transactions, performing computation services, reviewing documents, etc. Sensitive user's data are stored in an encrypted form, thereby eliminating the incentives to hack the user data database and stopping mass data breaches.

### FIELD OF THE INVENTION

The present invention generally relates to system and method for conducting business transactions in higher data storage security, and particularly to system and method for managing users' data that is shared, used, or accessed by persons that the users have no control.

### BACKGROUND OF THE INVENTION

Internet history reflects failure to secure consumer data. The Wikipedia shows a list of 251 well known data breaches for those involving the theft or compromise of 30,000 or more records and those involving large corporations. One common scene is hacking password database for accessing a large number of accounts. The actual number of breaches is magnitudes more. It is estimated that the total damage caused by data breaches is between $375 and $575 billion annually. This number is expected to grow rapidly. It is estimated that the average cost of a data breach will be over $150 million by 2020, with the global annual cost forecast being $2.1 trillion. Despite large number of patent grants in the U.S. alone, there is no sign that internet security can be improved. The internet data security failure is rooted in the incentive of business entities of creating the most favorable business ecosystem for hackers. The mass data placed on information highway creates great incentives for constant attacks. All new solutions can merely improve account authentication methods, use of two or more factors in authenticating users, and increased password length, and increased strength of encryption. None of those measures can be successful. Each new or improved method is quickly be cracked. History is repeated.

Failure of the internet security can be traced to the early trusted systems model. None of the prior art security methods can effectively prevent insider's attacks: Google Authenticator, FreeOTP, Initiative For Open Authentication, Key-agreement protocol, KYPS, One-time pad, Code (cryptography) § One-time code, OPIE Authentication System, OTPW, Personal identification number, Public Key Infrastructure, QR Code, S/KEY (one time password), Security token, Time-based One-time Password algorithm, Two-factor authentication, etc. In existing business systems, user data is stored in plain text. If they are encrypted, passwords can be found or constructed by using information stored on the server. All multiple-party security arrangements are vulnerable to abusive legal process. The use of personal biological identity information such as fingerprints, facial looks, iris profiles, DNA profiles, etc. will only compound more risks in the future and will make users miserable. After a new security method is used and tried, it is studied and cracked by hackers. History repeats itself.

Therefore, there is a need to develop a user system which enables the user to control business transactions at his own times, places, and preferences. And there is a need to find a methodology for safe-protecting user's data and eliminate the hacker's incentives.

Therefore, there is a need to develop diversified data security model for improving data storage ecosystem. A secured internet can be established only by changing the internet data security ecosystem. By eliminating incentives, hacking will disappear.

### SUMMARY OF THE INVENTION

The present invention comprises a personalized user system and method for authorizing a secure business transaction from the user side. The user system is a client computer or a cellular phone connected to one or more servers operated by or controlled by a business or entity. In this system, all business transactions are conducted on the business server, but the transactions are scheduled on the user's system and partially controlled by the user. User data are stored on the business server in an encrypted form only. Without the authorization, no transaction can be conducted. To make a transaction, upon user action, or upon reminder by the user system, the user is prompted to provide one encryption key for decrypting user data stored on the server or another computer so that the resultant usable data can be used in completing a scheduled business transaction.

In the user system, multiple transactions may be scheduled so that the user can authorize business transactions with different vendors such as gas company, water company, electrical company, hospitals, and credit reporting agencies, etc. The server operated and controlled by business transactions may also schedule multiple transactions respectively with different user systems. On the business server, all confidential and secret data are stored for in encrypted form. Thus, thief acquiring the user data database system cannot easily access user data because user data for different users are encrypted by different encryption keys.

In authorizing a business transaction, the user may overwrite an stored encryption key or any piece of encrypted information. The user system may include a feature allowing the user to schedule automatic business transactions by using a preset time and a stored encryption key.

The user system may includes a optional feature of displaying the date of the last completed transaction or a unique color indicative of a last transaction. In making the transaction, the user is provided with a conformation page to check the intended transaction to avoid error.

When the need to use the user data arises, the server sends a request for the user to provide an encryption key for decrypting the user data. Such a request may be sent to the data owner by an email with an embedded link a phone calls, faxes or an instant message. The obligations of both parties may be provided by contractual terms, understanding, regulations and/or laws.

Upon the user request for processing an intended transaction or upon clicking a link sent from email, the system, which may be the same server or a related server, generates a transaction-authorization page for the user on the user's system. This page contains unique information for identifying the user and the transaction to be processed. The user types in the encryption key or selects an option for getting an encryption key stored on the client computer, and submits the page to the server. Upon processing the request, the server gets the encryption key, and then retrieves encrypted user data from the server, decrypts the user data using the key to result in usable data. The server uses the usable data to conduct an intended transaction.

If the usable data is for only review, the data is used for the period of review. Upon the review being complete, the usable data is deleted permanently. If it is necessary to generate an article for limited circulation, it may be done so. After the review is completely, the usable data is not stored on the server and all temporary data is deleted.

If an intended transaction is only for one time, the server will use the authorization only once. If the intended transaction is to process a payment by using the existing method, the server will use the data such as a stored credit card number, user address, and credit card expiration date, etc. to process the payment on the server or a connected processing server. Upon completing the payment, the server delete or discard the usable data without saving them on the server.

User data includes important personal identity data such as birth day, social security, biological identity information such as fingerprints, blood types. DNA profiles, medical records, personal working histories, school records, working experience, and anything that a person may be interested in preventing the world from knowing. The data may be the type that concerns personal financial standing and financial liabilities such as banking information, credit card information, income source information, etc. Personal secrets may be anything the user wants to keep as secrets.

The types of transactions that requires the use of encrypted user data include payment, access to medical records and credit records, computation a, contract renewal, renewal of household contracts, renewal of insurance, application to schools, job application, personal information for relationship web sites, group editing of the documents, documents review by a group of people, documents processing by a group of people, and anything that would require any kind of personal sensitive data.

In one example, user data may be stored on a server, but also shared among a plurality of other persons in the internet. The data might be stored on user computers, the clouds, or shared drives. The user data may be subject to edits and changes. In another example, user data may be stored on a server to be shared among a group of people such as employees of a company, members of a family, and members of a club or a group. In another situation, user data may be stored on a server for an unspecified time, but must be used by the server in rendering required services or used by a connected server in providing its services. Exemplar services include computing services, problem-solving services, and digital data processing services.

In each of those situations, user data is owned by a person, who might be a consumer, an internet service user, or public member, there is preference to store the data on the server, and the data must be accessed by another person, the server, another server, or another computer system, or any combination thereof.

The subjects of this invention include modifying user data from an accessible form to user-key-encrypted unusable form, a method of creating such data, and an additional method of authorizing business transactions by providing an encryption key to decrypt the encrypted user data for a single use or limited use. Since the present invention can be used on different systems to improve user data storage security, each of modified systems naturally includes remaining components such as payment processing computer or a payment gateway, a telephone payment system, an email server in a network, a central computer, bankcard network/automatic clearing house, etc.

### INCORPORATION BY REFERENCE

This invention is intended to change ecosystem of data in the internet, the method is used to alter existing model of handling personal data. This invention relies on prior art as building blocks. Thus, following references are incorporated herein by reference in their entirety as it they are part of the disclosure: U.S. Pat. No. 11,250,142, issued Feb. 15, 2022, titled System and Method for Protecting Data in Business Transactions by Jianiqng Wu and Ping Zha; U.S. Pat. No. 9,449,183, issued Sep. 20, 2016, titled Secure File Drawer And Safe, by Jianiqng Wu; U.S. Pat. No. 7,051,002, issued May 23, 2006, titled Universal Merchant Platform For Payment Authentication, by Michael Keresman, Francis Sherwin, and Chandra Balasubramanian; U.S. Pat. No. 5,715,314A, issued Feb. 3, 1998, titled Network Sales System, by Andrew C. Payne, Lawrence C. Stewart, and David J. Mackie. In addition, the invention can be used to alter the performance of the following exemplar systems: U.S. Pat. No. 10,346,843 (Systems and methods for cost altering payment services), U.S. Pat. No. 10,339,525 (Confirming local marketplace transaction consummation for online payment consummation), U.S. Pat. No. 10,318,944 (Near field communication terminal for performing secure payment and secure payment method using the same), U.S. Pat. No. 10,296,902 (Payment device with data entry keys); U.S. Pat. No. 10,275,756 (Method of making secure electronic payment using communications devices that make use of a phone number or other alias in lieu of a payment instrument identifier), U.S. Pat. No. 9,595,031 (Payment via a messaging application), U.S. Pat. No. 8,515,870 (Electronic payment systems and supporting methods and devices), U.S. Pat. No. 10,235,669 (Real-time mobile wallet server), U.S. Pat. No. 10,339,746 (Mobile device for making a mobile payment), U.S. Pat. No. 10,229,450 (Generating sale transactions from voice data input by a user), U.S. Pat. No. 10,229,450 (Generating sale transactions from voice data input by a user), U.S. Pat. No. 10,108,960 (Method of completing payment through clients, related devices and a payment system), U.S. Pat. No. 9,934,784 (Voice data processor for distinguishing multiple voice inputs), U.S. Pat. No. 9,864,958 (System, method, and computer program product for video based services and commerce), U.S. Pat. No. 9,734,491 (Voice call payment systems and methods), and U.S. Pat. No. 9,626,703 (Voice commerce).

### BRIEF DESCRIPTION OF DRAWINGS

FIG. 1 is an schematic diagram illustrating a system and method of various embodiments of the present invention.

FIG. 2 is an illustrative screen view of a user interface for the user's business center on a client computer or a cellular phone (“user system”).

FIG. 3 is an illustrative screen view for a user interface for setting up an user account or a graphic check (an image check) for a server of an issue bank.

FIG. 4 is an illustrative screen view of a user interface for making a payment by using a text check or an image check.

FIG. 5 is an illustrative screen view of a user interface for making an inaudible payment while the user is in an active phone call over an active voice connection.

FIG. 6 is an illustrative screen view of a user interface for making an inaudible payment for making a payment by using a credit card payment (after the user has selected a credit card as a payment mode in a previous screen view which is not shown).

FIG. 7A is an illustrative screen view of a user interface for uploading payment data together with an encryption key to a server and a similar user interface may be used to set up a payment to be saved on the user client computer.

FIG. 7B is an illustrative screen view of a user interface for prompting a user to provide an encryption key in authorizing a business transaction.

FIG. 7C is an illustrative screen view of a user interface showing a confirmation message that a business transaction has been completed successfully.

FIG. 8A is an illustrative screen view of an exemplar user interface for viewing user's data that has been encrypted and stored on the client computer or a server.

FIG. 8B is an illustrative screen view of a user interface showing details of the encryption of the user data.

FIG. 9A is a flow chart showing the process for uploading and encrypting user data (e.g., owner data) with optional verification.

FIG. 9B is a flow chart showing the process for conducting a business transaction using a stored encrypted user data.

FIG. 9C is a flow chart showing the process for changing both the encryption key and user data or E-data.

FIG. 9D is a flow chart showing the process for changing the encryption key for stored user data or E-data.

FIG. 9E is a flow chart showing the process for changing user data stored on the server by using a user-provided encryption key.

FIG. 9F is a flow chart showing the process for conducting a verification test to determine if the stored user data is good and/or if the user-provided key is correct.

FIG. 10A is a flow chart showing the process for encrypting user's original data and transformed data and saving the encrypted data for later use.

FIG. 10B is a flow chart showing the process for decrypting encrypted user data and decrypting encrypted transformed data, and rendering resulted usable original data and usable transformed data on a client computer.

FIG. 10C is a flow chart showing the process for decrypting encrypted original data and encrypted transformed data by using an encryption key in volatile memory, and rendering the resulted usable original data and usable transformed data on a client computer.

FIG. 11A is a flow chart showing the process for editing user data on a client computer after the encrypted user data has been decrypted using a user-provided encryption key.

FIG. 11B is a flow chart showing the process for editing a series of encrypted data items on a client computer after the encrypted data items have been decrypted using an encryption key stored in a temporary location.

FIG. 12A is an illustrative screen view of a user interface for designating project members to provide personal keys, which will be used to generate an encryption key for encrypting data for a group or project.

FIG. 12B is an illustrative screen view of a user interface for determining how the encryption key is managed.

FIG. 12C is an illustrative screen view of a user interface for entering at least two personal keys that are used to generate an encryption key for encrypting and decrypting group data.

### DETAILED DESCRIPTION OF INVENTION

The terms defined in the following sub section are used in interpreting Specification and the appendant claims.

### A. Terms Used in This Disclosure

“Usable data” means that the data exists in a form that can be used for intended purpose. Data may include any kind of digital data including text field data, files and documents, word-processor files, image files, video files, sound files, and any digital data that is capable of being transmitted in the Internet and can be processed by Central Process Unit of a computer. For example, a document can be opened, read and edited by a person.

A video file can be played to show pictures; a sound file can be played to produce sound, a database data can be understood by a server program and can be reviewed by user. A setup file, configuration file, etc. that can be used by a computer program to execute intended functions is also in usable form. In contrast, when data is encrypted, it is not in a usable form. Encrypted data are not usable data.

Owner or user means a person or a legal entity that owns, creates, edits, controls, or possesses data which is the subject of protection. Owner or user may be an authorized agent, a representative of the true legal owner, or an authorized user of a group that own the data. When multiple persons assume the roles of owners, the one who is closet to the owner in interest, control and business relationship will be referred to as the owner, but persons who are more remote to the user may be referred as users.

User data can have following types: (1) Data that is used in daily communication, such as name, phone number, email address, and home address; (2) data that might be used in occasional situations or is associated with a person; (3) data that is used in routine business transactions; and (4) data that reflects personal views, political view, daily activities, business dealings, income, personal characters and reputation, and things that the user would like to protect. Some data need to be protected, but the need to protect data often depends on user's preference and choice.

### B. Change Data Storage Ecosystem in the Internet

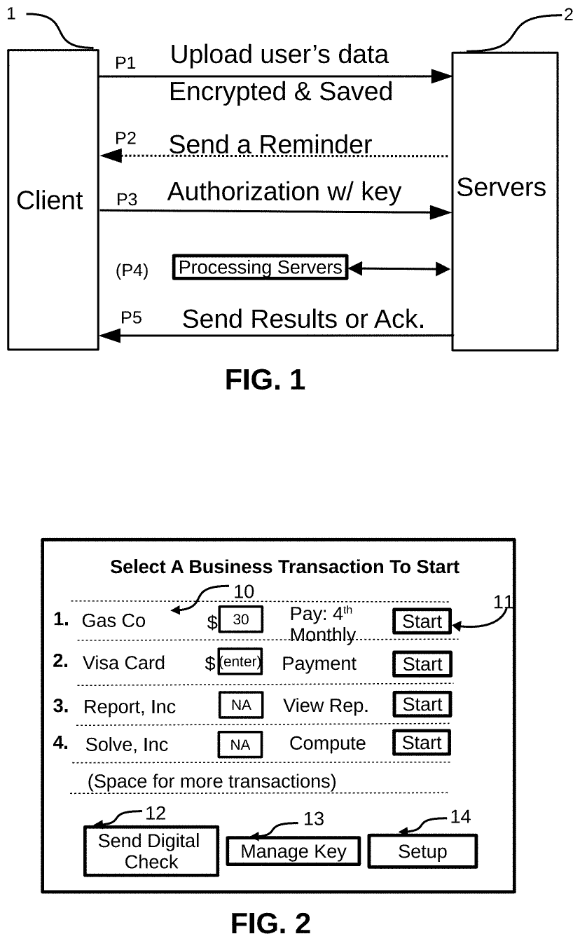

The invention is intended to change the data ecosystem on the internet. As shown in FIG. 1, a business transaction is conducted between a client 1 and a server 2. First, the user's data is encrypted by a user-controlled key at the client computer and sent to the server and stored on the server at process trip P1. When there is a need to use the data for conducting a business transaction such as payment on the server, the server sends a reminder as an option at process trip P2. The user then sends an authorization with an encryption key for decrypting the stored user's data at process trip P3 to generate usable data. The server then uses the usable data to process the intended business transaction at process trip P4. Upon conducting the transaction, the server sends an acknowledgment at process trip P5. Each of the process trip P1 to P5 may comprise multiple elementary trips. The multiplicity of trips arise from the fact that user-provided keys are from the client computer, a cellular phone (“user system”), and encrypted data may be stored in different machines and encryption keys may not be stored permanently on the server. All existing technology for protecting data transmission security may be used to protect data during transmission as in prior art. All business data from different users are encrypted by using different keys from different users. If the whole database holding user data is acquired by a hacker, the data is virtually useless.

The software developed for practicing this invention includes the server-application, the code for controlling the client computer and code for execute any transactions. Solely for convenience of disclosure, all software components that jointly perform a well-defined function may be referred to as a component.

### C. Changes in Rights and Obligations

This arrangement alters the convention that the business has a total control over the user data. To make this system workable, the rights and obligations on managing user data must be modified by agreements, common understandings, regulations, trade regulations, statutes, state laws, local laws, etc. The merchant may use user data of another person only when there is a need. After use of the user's data, the data is deleted or discarded. The data in the usable form may be saved on the server only for a limited time or just sufficiently long for completing an intended business transaction; and the user is obligated to provide an encryption key to decrypt stored data per their agreements. In making a payment system, the merchant must use a gateway, a payment processor, a central computer connected to a bankcard network or automatic clearing house, etc. Each of involved party follows the same rule.

### D. A User Business System for Conducting Business Transactions

FIG. 2 shows the screen view of a user interface for conducting business transactions in the user system. The user interface shows a plurality of business transactions 10. For each transaction, there is a button like Start 11 for starting a business transaction. In addition, it has three buttons” which may be place in other user interfaces. One for sending digital check 12 which enables the user to issue a digital check for any person, a button for managing encryption key 13, and a button for setting up business transaction (adding or deleting transactions).

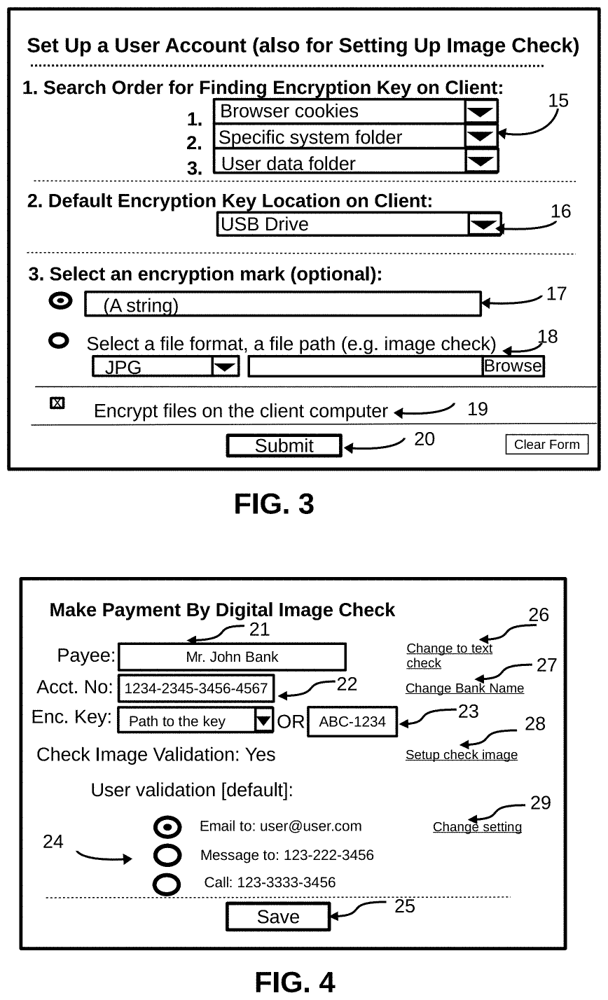

FIG. 3 shows the screen view of a user interface for setting up a user account or setting up the function for issuing image checks. The user interface enables the user to set up a search path for finding a stored encryption key 15, select a default key location 16, provides an encryption key at 17 or alternatively upload an image as encryption mark at 18, and select a client computer or server as default for making encryption at 19. Upon completing the form, the user submits the form to have the data saved on the server that is associated with the business transaction. As an option, some user data may be stored on the client computer.

### E. Two-Way Credit Accounts and Digital Check

A most efficient payment system is two-way credit account or bank account for both receiving fund and sending fund between any two persons. The fund moves from sender's account to the receiver's account. If fund is transferred between two credit card accounts, transaction will start with sender's request to transfer fund from the sender's issue bank to the issue bank of the payee. The transaction is completed when the sender's account is debited with the payment amount and the receiver is accredited by the sending amount. This type of payment transaction cannot be made over the internet because it is impossible to tell between sham checks by cam artist, unauthorized checks by bank insiders and repudiation by the payers. The high security feature of the present invention can overcome all those technical difficulties.

There are two kinds of digital checks: text check or digital image check. A text check is only an instruction for issuing a payment. Digital image check is similar to a traditional paper check which can be sent to any merchant or person as a payment. The image check may contain special or distinctive image, user's signature, signs and marks, quick response (QR code), water mark, other distinctive image, other security feature, or their combination. A copy of the image check may be created and uploaded on to the server of the issue bank and saved on the server in an encrypted form. This will prevent an insider from issuing a check. In drawing a check payment, the image check is added by a computer program with payment information such as amount, payee identity and date of payment. The cashed imagine check will be marked with signs that payment has been made.

A digital image check may be created at the business center such as the cellular phone. The digital image check is sent to the issue bank with an encryption key, the server encrypts the image by using the key and saves it for later validation of issued imaged check. An image check may be issued by the user at the cellular phone and sent to the issue bank or the server or device of any acquiring bank of payers. If an image check is sent to the issue bank, the issue bank validates the image check against the stored digital content of the image check which has been decrypted by using the user-provided key. The validation may be conducted by a computer program by comparing designated security features in the stored image check and the presented image check. If the amount of payment is large, the issue bank may optionally ask the user to approve the payment by using email, phone call or instant message. Upon validation, the issue bank then adds markings onto the image check as indication of being cashed and transfers the amount of money to the acquiring bank optionally together with the cashed check image. The acquiring bank adds the transferred fund to the account of the payee.

In an alternative, an image check may be sent from the user business center directly to the server of the acquiring bank of the payee with a notice sent to the payee. The acquiring bank may not permanently save the imagine check or must be protected safely. The payee cannot make a copy of the image check before it is cashed. The acquiring bank then sends the image check to the issue bank of the payer. The issue bank validates the received image check against the digital content of the image check that has been generated from decrypting the stored image check using a user-provided key. Upon validation, the issue bank transfers the amount of payment to the acquiring bank, adds markings over the image check as a cashed check and completes the payment transaction. The issue bank may send cashed check images to the user as part of monthly statement or makes cashed check images available for download.

In creating a text check, the user provides an encrypted key to the server to decrypt the encrypted digital mark before the server can generate a text check with all required payment information. To prevent issuance of a fake text check by a bank employee, an optional requirement is for the user to validate the user's identity by decrypting a saved encryption mark and make a determination that the resulted mark generating from the user-provided key is identical to the mark that has been generating from decrypting a password-encrypted mark by the server. This step can prevent an insider from creating a text check without authorization. It is highly preferable that bank employees who oversight check cashing function may not have access to the server dedicated for generating text checks. It is preferable that issue process and cashing process are done by automatic system actions so that a fake payment cannot be completed by collusive acts of two employees. In addition, the payment may be completed only after the user has approved the payment by email, instant message, phone call, etc.

FIG. 4 shows the screen view of a user interface for creating a digital check by clicking the button 12 in FIG. 2. This user interface in FIG. 4 may be opened by clicking a menu on a client computer or the menu on a cellular phone. The user interface enables the user to enter data into a payee name field at 21, an account number field at 22, and an encryption key path or the key at 23. This user interface also shows check validation method which has been set up by the user and saved on the server. In addition, the user interface enables the user to select one method for user to approve the check payment at 24. In addition, the user interface enables the user to change check type from an image to text check using the Change to Text Check link 26, change the bank name by using the link 27 (the bank name is associated with account number), or change the check image (as the check's background imagine) by using the link 28, and select a payment-approval method by using the link 29.

### F. Make an Inaudible Payment Over an Active Voice Connection

Making inaudible payment over active payment is known. The purpose is to reduce the risk of getting credit card and personal data by eavesdroppers. By using the present invention, payment information may be encrypted and saved for recurring use. Even if card information is not saved for recurring use, this method can reduce the plain view of payment information to the minimum or seconds.

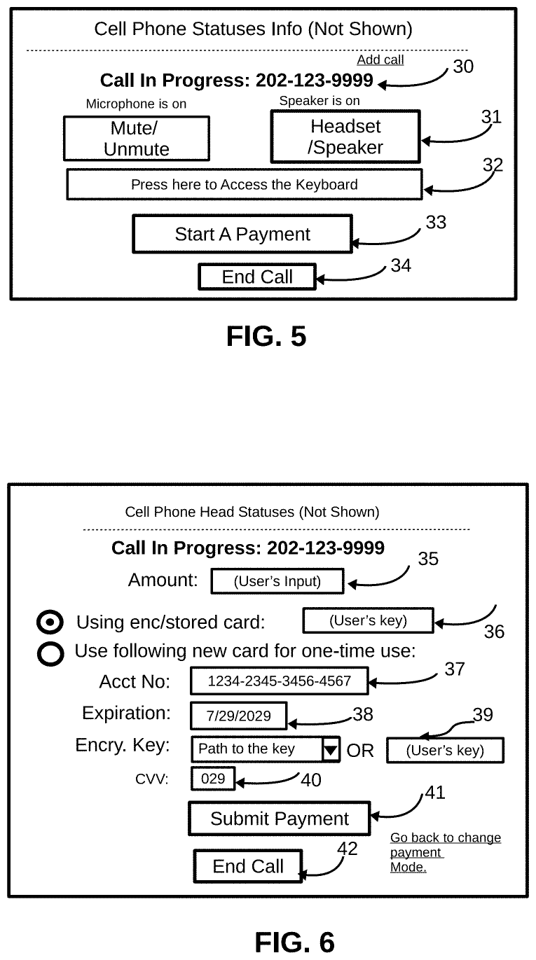

FIG. 5 shows the screen view of a user interface showing the first page for making a payment over an active voice connection. This user interface may be rendered by clicking a link on the user interface of FIG. 2, an icon on the phone menu, or a menu in a desktop computer. The screen view shows the phone number 30 in call in process, speaker phone switch 31, a key board launching button 32, and a call-end button 34. It also has a button 33 for starting making a payment (this may be initiated by a voice command). Upon pressing the button 33, the system shows a plurality of payment methods (such as credit card, digital check, paypal, Apple pay, etc.). Upon user's selection of credit card, the system shows a user interface for making a credit card payment, as shown in FIG. 6.

FIG. 6 shows the screen view of a user interface for making a payment. The user enters the payment amount in amount field 35. The user selects one of two options. In the first option, the user selects a previously stored payment method by sending an authorization comprising the amount and encryption key. Upon receiving this authorization by the associated server, the server retrieves encrypted card data from the server, and decrypts the encrypted car data to generate usable card data and uses the card data to process the payment in the amount in the authorization. Card type may be added optionally but is reflected in the credit numbers. It then responds with an acknowledgment. If the user selects a second method, user just provides the required information including the internet address. Upon submission, the server will make the payment. Encryption may be performed at the client computer. By changing the fields in the user interface, inaudible payment information may include other information such as digital image of photo ID, digital image of payment card, or personal identity, data stored on a magnetic stripe of a payment card, and data stored on a microchip (e.g., a smart card chip, and a radio-frequency identification chip) of a payment card. The user system may be configured to detect one or more predefined voice commands spoken by user as a request to start making an inaudible payment information to the merchant over an active voice connection.

Active voice connection may be established, maintained, and/or terminated using any suitable voice communication technologies such as PSTN, CDMA, TDMA, GSM “VoLTE”, VoIP and any combination. If merchant device is not a server, the device is equipped to receive and process inaudible payment information. The active voice connection includes a suitable routing path over a packet-switched network, payment management component on the server may direct the user's system to use the same routing path settings and/or endpoint information (e.g., same endpoint addresses and/or ports) to transmit the inaudible payment information over a suitable path over the packet-switched network, without having to establish a different connection. The payment management component may direct the user system to transmit the inaudible payment information over the active voice connection using the same band, ports, codec, session, and/or channel that is used for active voice connection. In certain examples, the payment management component may direct user system to use a designated special frame or frame type within a protocol (e.g., RTP frame type x). If the active voice connection includes an analog connection, it is necessary to perform digital-to-analog conversion operations to put the inaudible payment information in a form that is ready to be transmitted over active voice connection.

### G. Payment Systems

In this embodiment, user data is a credit card number, banking account number, together with required data for making a payment. This embodiment includes a method for creating and saving encrypted data on the server, a method for using an encrypted key to process a payment, and the method for confirming the result.

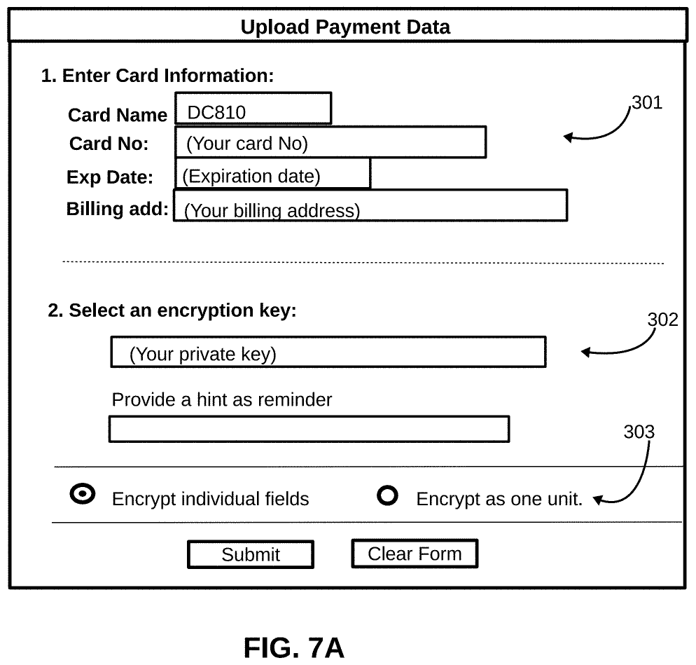

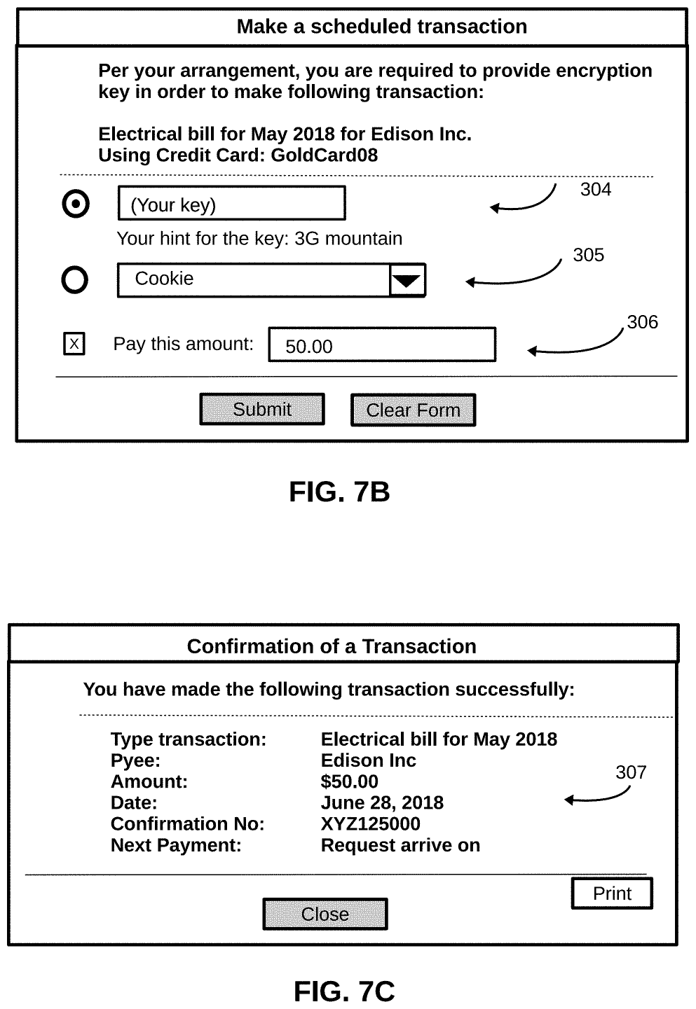

FIG. 7A shows an exemplar user interface for uploading payment data. The user provides credit card data and billing address (Block 301), a user-selected encryption key with an optional hint (Block 302), and method of encryption (Block 303) (any suitable methods may be used). Similar forms can be designed for uploading user data. User data to be encrypted may be any combination of different forms of data. Check boxes may be placed next to each of potential data fields so that the user can select from them the fields to be encrypted.

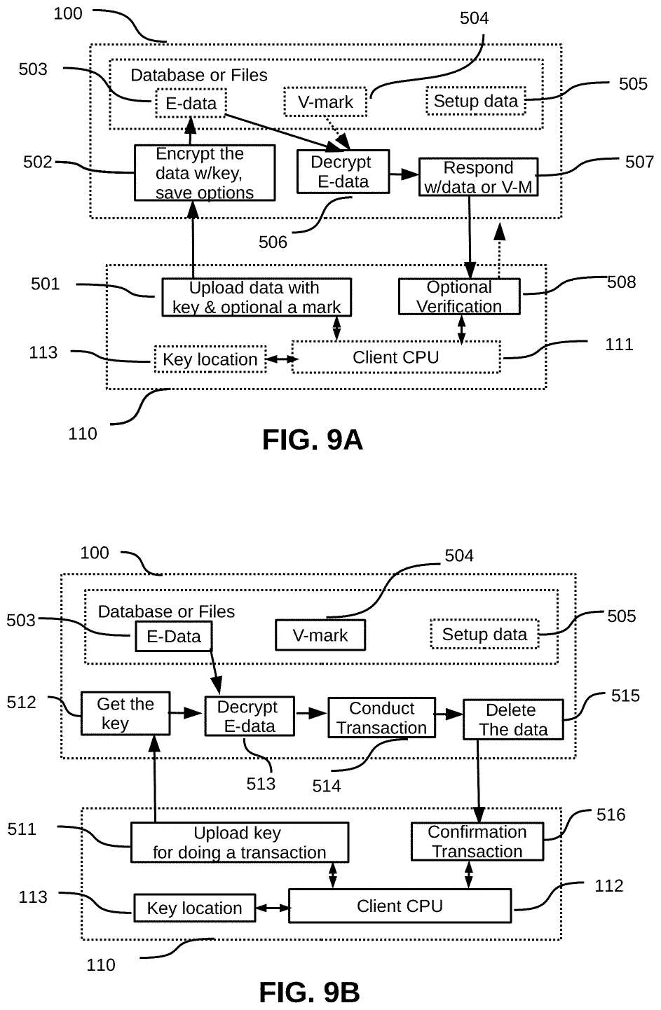

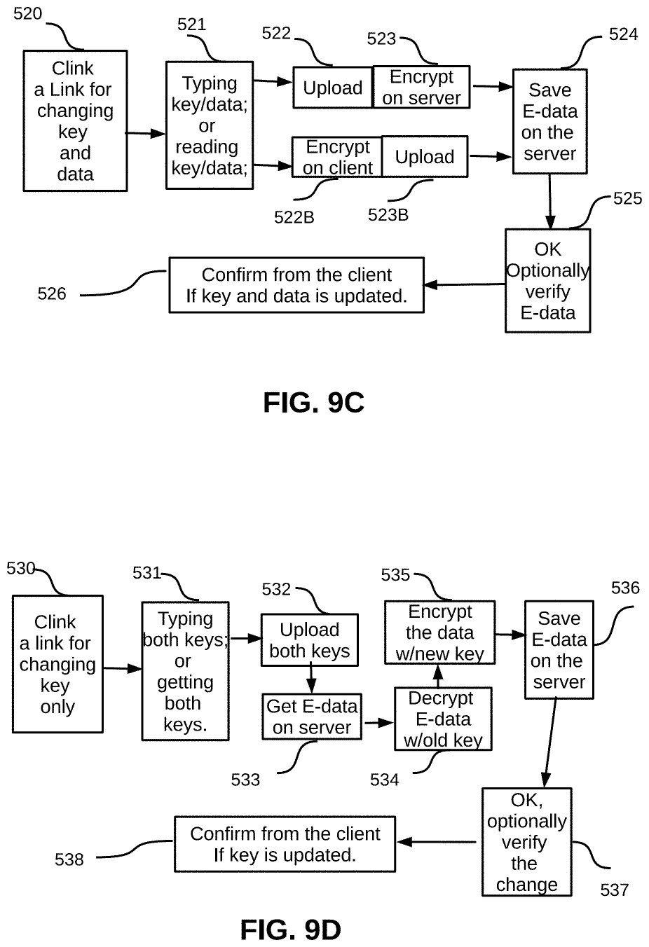

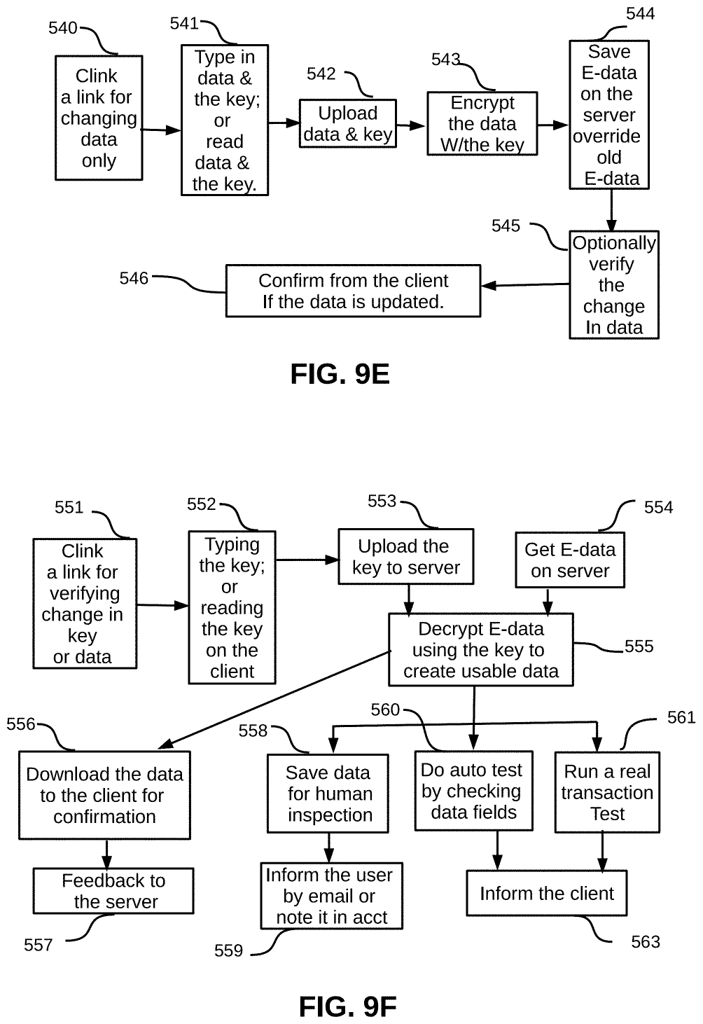

FIG. 7B shows an exemplar user interface for authorizing a scheduled payment or business transaction by using saved encrypted payment data. The user provides an encryption key in Block 304 or selects a method or the key location to get the encryption key (Block 305). Options in the drop-down include file location, search path, search order, cookies, USB drive, smart card device, etc. The client computer prompts the user to select or find a specific device or folder upon the user selection of an option in the drop-down 305. On this user interface, the user can also include new data such as new amount in Block 306 to override a default amount of the scheduled payment. The new data may be originally suggested by the server. Obviously, the user interface can be modified to allow the user to include other data which can modify, supplement, or overwrite the stored user data. This user interface is used in Block 511 in FIG. 9B and other similar situations.

The step of authorizing business transaction discussed in FIG. 7B may be done by email, telephone call, instant message, micro message, or voice commands as discussed below. In each case, the user accesses the system, authenticates his identity by any method such as verifying his account password, email address, phone number, customer ID or personal PIN or any combination thereof, the user is prompted to provide the encryption key for decrypting the stored payment information with an payment amount. Upon getting the key, the system gets encrypted payment information and decrypts payment information using the user-provided key to generate usable payment information. The rest transaction will be done in the same way as prior art.

In one exemplar embodiment, the server sends an email message to the user before scheduled time of making the payment transaction. The email may contain a link which, upon clicking, will provide a user interface for sending an encryption key. This link contains sufficient information for identifying the user and/or the scheduled transaction. The email may contain a text containing a unique string or code together with an instruction for providing the encryption key in a specific location such as “. . . .[key string-location]. . . .” as long as the processing program knows how to capture this encryption key from the returned message. In an alternative, the encryption key may be written in Unique_name=value pair format and the program get the value by searching the name. This email has a special returned email address of the business and instructs the user not to write in personal data. The user then fills the encryption key in a specified location or as a name's value and sends the email to designed return address. The email is received by a special email server which may be a payment-assisting system that does not allow any employees to read the email. Instead, the server processes each of such a transaction authorized email by capturing the unique string or distinctive name to find the user account and the associated business transaction.

One or more data fields in a prompt email may contain business-provided data and optionally one or more pieces of user data to modify or overwrite saved user data for the currently scheduled transaction. The server then uses the stored user data, newly arrived user data (such as amount and a new payment date) and the encryption key to process the payment. After the payment is successfully processed, the server deletes the email entirely or the encryption key from the email so that the encryption key cannot be recovered by employees. Optionally, the email server may be integrated with a payment system.

The payment may be authorized by using an instant message from a cell phone. For example, several days before an expected date of the scheduled payment, the server sends an instant message to the cellular phone of the user, together with a unique transaction code or ID in the text, a string or URL including a string for identifying the intended payment transaction. The message may contain information on limiting time windows for making the payment but the time limit may be stored in the user's account on the server. To authorize a payment, the user returns the same message together with an encryption key and amount of payment in a suitable format to the return address. Upon receiving the message, the message triggers a program to process the message: retrieving encrypted payment data, extracting the encryption key from the message, decrypting the payment data with the encryption key to produce usable payment data, and using the usable payment data to complete the payment. In the server, payment messages from multiple users may be processed according to their arrival times or processed at scheduled times. Upon processing an authorization message and completion of the payment, the server then sends an acknowledgment message to the cellular phone of the user.

The authorization may be conducted by using a telephone payment system which is used by most banks. The user gains access to his customer account by providing personal or account information. The user selects a scheduled payment transaction from a list of prompts. The payment system prompts the user to provide an encryption key and amount of payment, uses the key to decrypt the encrypted payment data to produce usable payment data, and use the usable payment data to complete the payment transaction. In this system, the user's payment data can be securely stored for recurring use.

A transaction authorization may be optionally conducted by using voice commands for the user system. The technology of making voice payment is well known as fully disclosed in those cited patents such as U.S. Pat. No. 9,734,491 and well known prior art. After the cellular phone is activated with voice command feature and an active voice connection is established, the authorization may be issued by voice. The voice instruction includes optionally a calling program, business name or transaction identity, and an encryption key. For example, it may follow the format: “business name or unique transaction ID, encryption key: 123456”. An authorization command may be in natural language like “make a payment to XYZ bank with encryption key: 123456.” Optionally, the voice instruction may include an overriding data piece. For example, “make a payment to XYZ bank with encryption key: 123456 overriding the amount with $20.” The phone responds by repeating those key words, and prompts the user to confirm with “go” or “OK” to complete the transaction. The cellular phone extracts relevant terms and sends them to the server to cause the server to process the transaction. It then constructs a responsive message and sends the message to the cellular phone to be rendered as a confirmation or acknowledgment message. If the business transaction cannot be conducted in real time, the responsive message may be sent as an email message, instant message, or automatic phone call.

As an optional feature, the voice authorization may be conducted by voice dialog between the user and the server over an active voice connection. The client computer does not need to decipher the meaning of the voice commands, but just relay the voice instruction to the server (like communication methods used in Skype, Zoom, etc.). The server interprets the voice instruction to extract the transaction identity information optionally with the user identity, the encryption key, and optionally overriding data pieces. Upon successfully getting required payment information, the server then passes the information to a processing program to conduct the transaction. Upon completing the transaction, the server constructs a voice message and sends it to the cellular phone as a confirmation. The server may send a responsive message as an instant message, micro message, email message, or automatic phone call.

The authorization may be done by the user at his own volition. The user may initiate and send a payment authorization including a unique transaction identification information, an encryption key, and payment amount. Upon receiving the message, the server uses the encryption key to decrypt the stored payment data and make the payment transaction. In alternative, upon user's clicking of the URL embedded on the instant message, the cellular phone or the client computer opens an associated web page which prompts the user to enter the encryption key and amount to finish the payment transaction. The user may be required to provide the user's identity as additional validation or make the payment without providing additional validation of the user's identity.

FIG. 7C shows a confirmation message at Block 307 indicating a successful payment or business transaction. The confirmation or acknowledgment may be sent to the custom user interface which can accept message all time, the web page which has been used to send the authorization, the user's phone number as an instant message, an email message which may be accessed as web mail, or email which may be opened by a email client.

### H. Management of User's Data

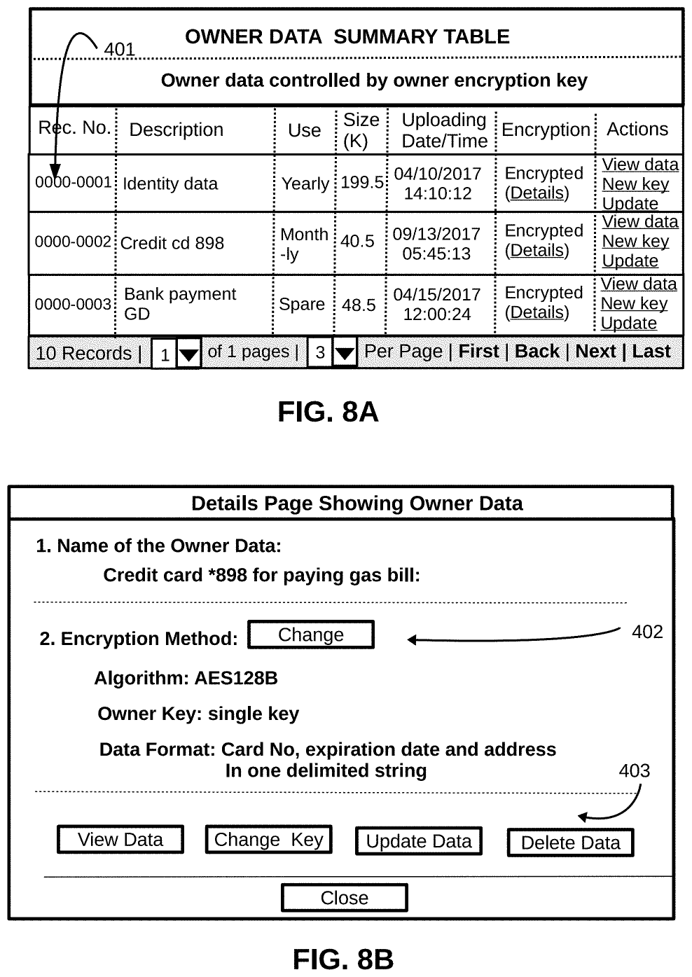

FIG. 8A shows a user interface showing “User Data Summary Table.” (“user” and “owner” are used interchangeably). This table shows user-key-encrypted data. After the user logs into the account on the server, the user can see the table. The page contains one or more data entries. A data record No. or name may be used to identify the data. Each number or name (as shown in Block 401) may be a link or button for opening Data Details page for that data record. Each of the data has action links: “View Data”, “Update Data” and “Change Key.” Some exemplar operational steps are shown in FIGS. 9C-9E and discussed in related descriptions. A “Deletion” link may be placed on this table for the user in some business contexts, but is available to the server employees.

The table shows data by a number, description, size, uploading date and time, encryption method and actions. The user data might be a single field data piece, multiple fields data, text file, sound file, video file, a native file for application, or any combination of thereof as long as it can be used to conduct the business transaction. Different types of data may be combined for convenience of doing business transactions. Each data record may be defined by a data record, description, creation time, size, and encryption method or algorithm, and optional status.

Encrypted user's data can be accessed by clicking links or buttons that may be placed on the User Data Summary Table, a Data Details page, or other view arrangements. Each of the data records on a table is associated with a link or button of “Decrypt” while usable data records may be downloaded by using a “Download” button (not shown).

The data like FIG. 8 may be stored on the user system, a server or multiple servers. For example, a merchant server may have such a data table containing user data for different users. A user system may also have a similar data table for business transactions for this own. In the system, the user system and the server are connected, business data can be exchanged easily. User data of credit cards are used one time only for each transaction. There is no need to maintain this kind of data consistently. The user may use stored card data by default, but may choose to use encrypted card data that has been stored in the user system. If a payment using a card stored on the server fails, the user may make a payment by using an encrypted card from his cellular phone.

User data may be processed and encrypted in any of various formats: encrypted single piece of data, a plurality of separately encrypted data pieces, an encrypted data object comprising multiple data pieces separated by delimiter, encrypted text file, encrypted native file, encrypted web page, encrypted plural web pages in a folder, encrypted zip file which may contain folder and sub folders, encrypted video file, encrypted audio file, encrypted database file (records, whole or partial table, or whole or partial database), encrypted native file for applications. Credit card data includes credit card account number, expiration date, and payer address or zip code. Those data fields may be encrypted individually. For example, an encrypted data may look like: NameOnCard: Xv asQry S CardNumber: 9872344353492934; ExpirationDate: Expdate. Any suitable format can work. In an alternative, the individual data pieces are first appended to form a single string containing proper delimiters, encrypted using a user-provided key, and stored on the server. In using it, the server first uses the user's key to decrypt the data, breaks up the data at delimiter points, and gets all individual data pieces for use in processing the business transaction.

Other types of user data may be directly created as a web, and then encrypted by using a user-provided key, and stored on the server. Before using the data, the server uses the user-provided key to decrypt the encrypted web page, resulting in a usable web page. The usable web page may be used directly by the server in conducting the intended transaction or after being processed by updating certain data fields such as payment date and amount. The program may be on the same server, run in a different server such as a payment server, a computing server, a design server, a problem-solution server, etc. to process an intended transaction. The usable web page and the encryption key are deleted, discarded by a servlet action, or trashed with the memory being reused by the server.

After the encrypted data is decrypted, the resulted data is directly usable, can be further processed for use, or can be transformed to another usable form. Data transformation such as creating delimited data and breaking delimited data is well known in the art.

Some details may be shown in a “Data Details” page by clicking any data entry number or data name link. Data Details page contains more details that cannot be placed on the Data Summary Table. Data Details page may contain the basic information such as data record number and description. Other details may include uploading date and time, detailed encryption method, fields of data, file size, verification status, file status together with several operational buttons. “Encryption details” may optionally contain information on the encryption algorithm, number of personal keys used and the scheme name for constructing the encryption key. This field should provide the user and servers with sufficient information for selecting encryption algorithms and reconstructing encryption keys, but avoid disclosing information that hackers can use. Other details may include uploading date and time, file size, verification status, and other optional features. It shows how the data is structured (data piece, appended data pieces with a delimiter, a compressed or uncompressed zip file, combination of different type of data).

FIG. 8B shows detailed information about a user data entry, “Change” for changing encryption method in Block 402. Some operational links or buttons in Block 403: “View Data” or “Verify Data,” “Update Data”, “Change Key.” It may optionally contain links and buttons for “Delete Data” and “Change Hints”, etc. “View Data” or “Verify Data” is for verifying data condition. It requires the user to provide the encryption key to decrypt the data. It may include a step of checking data field, conducting a test such as a making a test or real payment, conducting a computation, presenting a web page, etc., or prompting the user to inspect data on the client computer. “Update data” is for the user to change user data, this normally requires a user-provided encryption key unless a key management method is used. “Change Key” is for the user to change the encryption key. This function requires the user to provide both the old key and a new key. “Change Hint” may be used to change hint that is presented on this page. “Delete Data” is for deleting this user data record. This option may appear on the user view, or just for the server employees. “Active” is used to allow the user to designate a data record as active or inactive. For example, one credit cart is used as active, while other two are entered as spare or inactive. Optionally, additional functions may be placed, allowing the user to choose data fields for encryption. If the user chooses to encrypt a field, the user is prompted to enter an encryption key with an option for entering a hint for this key. It is understood the view plain text function is not available to employees of the server or other connected computers. It it available only on client computer.

FIG. 9A shows the process for creating user-key-encrypted payment data. The user on the client computer 110 uploads payment data at Block 501. The user provides payment data, an encryption key, and optionally encryption mark at Block 501. After the data is uploaded, the data is encrypted using the key at Block 502, and saved on the server at Block 503. The server may optionally conduct a decrypt test. The server first gets the encrypted data (referred to as “E-data”), decrypts the E-data at Block 506 to get usable data. The server creates a response with the usable data included in the response at Block 507, and presents the usable data to the user for inspection on the client computer at Block 508. The user ends the process or sends feedback to the server to confirm the result.

The payment data may be encrypted by individual fields or encrypted as one single piece after all field data pieces are combined to form a delimited data. The upload form may allow the user to select a key location at Block 113 (e.g. a path or device) for finding the encryption key. V-mark is an encrypted mark which is produced by encrypting the same mark with account password. The details of using V-mark (“v-m”) to test if an encryption key is correct was disclosed in the incorporated U.S. Pat. No. 9,449,183.

FIG. 9B shows how a payment is made by using stored encrypted payment data. When the user submits a request including the key at Block 511, the server gets the key at Step 512. The server gets encrypted payment data (E-data) from Block 503, decrypts the payment data at Block 513, resulting in usable data in temporary memory. The server then uses the usable data to conduct a payment transaction at Block 514 (this step include all required steps involving payment gateway or central computer connected to a bankcard network or Automatic Clearance House). Optionally, the server may validate, transform, or process the usable data before the server makes the payment using the usable data. After the payment is made, the server deletes or discard all usable data at Block 515, and sends a confirmation to the client computer at Block at 516.

The data parsing method is consistent with how the field data are created. If data is appended and encrypted as a single piece, the data is decrypted and is then split.

In the page to send the encryption key, the user may designate the key location at Block 113. The setup data 505 contains information on where to find the encryption key by default.

FIG. 9C shows the steps for changing both user data and encryption key. The user clicks a link or button for changing both user data and the key at Block 520, provides new data and a new key, or causes the client to read the data and the key at Block 521. The data and the key are uploaded to the server at Block 522 where the data is encrypted by using the key at Block 523. In the alternative, the data is encrypted by using the key on the client computer at Block 522B and encrypted data is then uploaded to the server at Block 523B. The encrypted data is saved on the server at Block 524 to replace old encrypted data. The server optionally verifies the encrypted data at Block 525 by using the verification process shown in FIG. 9F and finally informs the client computer at Block 526.

FIG. 9D shows the steps for changing the encryption key. The user clicks a link or button for changing the key at Block 530, provides the old key and a new key, or causes the client computer to read both the old and new keys at Block 531. Both the old and new keys are uploaded to the server at Block 532. The server gets the encrypted data associated with this link on the server at Block 533, decrypted the E-data by using the old key resulting in usable data at Block 534. The server then encrypts the usable data by using the new key at Block 535, and saves the encrypted data as replacement E-data on the server at Block 536. The server informs the client computer at Block 538, with an optional step of verifying the encrypted data at Block 537 by using the verification process shown in FIG. 9F.

FIG. 9E shows the steps for changing user data only. The user clicks a link or button for changing the data at Block 540, provides the key and new data or causes the client to read the new data and the key at Block 541. Both the new data and the key are uploaded to the server at Block 542. The server encrypts new data by using the key at Block 543, and saves the encrypted data as E-data on the server at Block 544 to replace the old encrypted data. The server informs the client computer at Block 546, or optionally verifies the encrypted data at Block 545 by using the verification process shown in FIG. 9F.

FIG. 9F shows optional steps for conducting a verification test. The user starts a verification test by sending a request or upon clicking a link or button calling a verification page at Block 551. The server asks the user to provide an encryption key or select an option for the client computer to find the encryption key at Block 552, sends the key in a proper form to the server at Block 553, and uses the key to decrypt stored encrypted data (E-data) and optional V-data at Block 555 (V-data is not shown in the figure). The usable data is downloaded to the client computer at Block 556 and sends feedback to the server at Block 557.

In the alternative, the test step may be performed as follows: the server may save the data for human inspection on the server at Block 558, conduct an automatic data validation by comparing the two resulted marks or by checking field data digital characteristics, word length, and appearance of words and phrases, etc. at Block 560, or run a real transaction test such as making a payment, doing a search, conducting a computation, processing data (e.g., sorting data, arranging digital characters, replacing characters, playing sound, rendering video picture, generating a web page, creating data table, etc.) at Block 561. The server informs the client whether the auto test or the transaction test is successful at Block 563. Upon finishing, the server may optionally send an email message to the user, confirming the change of encryption key.

The methods discussed in FIGS. 9A to 9F are also applicable to user data for other business transactions to improve their storage security.

### I. Invention Used To Modify Other Business Systems

The present invention is used to improve payment technologies by changing the internet ecosystem. One common payment method is recording payment credits for a series of transaction and then making a final payment. In this type of payment transactions, user data is used each time in processing a payment. In this case, the business transaction is assisting the merchant to use the user's data each time there is a need.

1. Protecting user data for utility companies

Another type of common methods is widely used in the billing systems of utilities companies such as electrical companies, water companies, gas companies, government agencies, and organizations. In such a billing system, the customer data such as credit card numbers, banking account numbers, and other sensitive data are stored in the database of the billing system. The key modifications are: at least one credit card account number or other payment account number, together with other information, is saved on the server by using a setup page or by making a first payment. Thus, the account number and the designated sensitive information are encrypted on the client computer or the server, and are saved on the server. In making a payment, the utility company or the merchant gets the encrypted account number together with other data from the server, causes the encrypted account number and other encrypted data decrypted on the client computer or the server, and then sends a payment request including the account number to a payment gateway or central computer, which then causes the issuing back to transfer a required amount of fund to the deposit account of the acquiring bank of the utility company. Detailed arrangements are well known and are used in routine payment transactions.

In this payment transaction, a payment gateway, like a payment processor, transmits payments between the customer's (e.g., the user's) bank and merchant's bank. It is primarily used as a tool for e-commerce or card-not-present transactions. The gateway authenticate the user's credentials to prevent possible bank card fraud.

Another payment system is shopping carts, which are used by online merchants or business entities, where the customers may store credit card numbers and sensitive personal data. One version of shopping cart is disclosed in the U.S. patent No. U.S. Pat. No. 5,715,314A, all details of which are expressly incorporated by references as if they are fully disclosed. The user data (e.g., the customer's data) is entered by the customer during the payment step or a setup step and is stored on the merchant server; when the customer checks out, the server includes a summary page showing description of items in the shopping cart together with one or more stored payment methods without showing details; when the user selects a payment method from the stored payments, the server updates the summary page by showing the selecting payment method with partial name of the card; this summary page includes at least one data entry field for accepting an encryption key prompts the user to fill in the data entry field an encryption key/decryption key and to make a final submission, the server uses the user-provided key to decrypt the stored account information on the server, and, upon validating the account information, the server uses the usable account information to complete the rest payment transaction. All credit card information, access authentication data, payment authorization, etc. used in the transaction may be further encrypted during transmission by using any security measures such as secure socket layer, etc.

The third-party payment system contains a large number of user accounts so that money can be transferred from a payer/sender to a payee/receiver. In such a system, each user has to save a bank account or credit card and other user data necessary for making a payment. The whole database is vulnerable to insider attacks. Thus, the payment system is modified by adding an encryption step and authorizing step for making each payment. The invention by Tunnell et al, disclosed 10,269,010 is intended to mitigate risks that arise from the user sides log-in process and can be added on the present invention as an additional security feature.

The modifications of existing business transaction methods are adding an encryption step to encrypt user data and using authorization step for making a payment. The user must provide a right encryption key to decrypt previously encrypted user's data on the server, or download the encrypted data to decrypt on the client computer and send the usable data back to the server for one time use. All of those processes can be completed by using a customer system without using commercial browsers.

The secured payment method may be used to improve payment security at point of sale. In the prior art, the payment information is not encrypted permanently by user-provided encryption key and the payment data is used only once without being saved. However due to improved data security, payment information may be encrypted with a user-provided key and saved in the memory of the connected system for future use, upon user's selection. In the future, the user may conduct a payment transaction without presenting the card, but entering only an encryption key. A further modification is that credit card strip or chip may contain user-key encrypted card information and necessary personal information. This will make card numbers invisible in commerce, but only appear in credit card statements.

A database that is stored as encrypted data. Any personal information such as credit card, bank information stored as encrypted form in any of the known suitable format such single piece and delimited text stream. The information is store on the cellular phone. If there is a need to make a single transaction, upon the user action, the cellular phone will promote the user to provide key or simply provide the location key, have the encrypted data to become a usable data and then transmit the usable data to server run and operated by entity such as bank, gas company, electrical or stores, which will use the data one time only without being saved. Upon successful process, the server sends a confirmation message to the cellular phone. This method alters the data safety ecosystem because the user does not need to save payment data on the server, and the user does not need to go through the long process to enter personal information, address, card information. The total burden is thus reduced to enter an encryption key and recipient internet address. In the alternative, particularly if the payment is recurring, the user may simply upload the encryption data to the server for storage and then make each payment by sending an authorization each time.

Recurring payments may be initiated by the cellular phone. According to the scheduled data, the client computer promotes the client to send payment on its own. If the payment is not received, the server may also promote the user to make payment.

Preferably, the email may be encrypted for protection of transmission. In another modified method, upon user's clicking the embedded link in the initiating email, the server will open a global transaction authorization form, with or without logging into the user account. The user then fills data (encryption key and any data to be over written) in the form, and sends the filled form to the server. The server uses the unique string or identification code as part of URL to associate the form with the user and the scheduled transaction. The user makes authorization by submitting the form. If the user is unable to submit a filled form due to heavy traffic or network problem, the server non-responsiveness, etc., the user may email the filled form as a secured email to the special email address of the email server, the mail server will capture all required data to process the scheduled transaction, and delete the email or user data from the email. This email delivery option can help the user avoid the logging into the server.

At present, a fully functional web form cannot be embedded on most email clients, but can be developed. There are already examples that it would be possible to make e-mail an effective tool. If email clients implement web standards, delivering web forms by email is one of the best methods. Gmail, Yahoo mail, and other online web email may work also. Before the form function is fully implemented in the web email, a transitional option is to use distinctive marks and value pairs to carry user data so that the email server can capture user data for processing an authorization.

The general concept disclosed in the first embodiment is equally applicable to other business situations where user data are used by the server. In another embodiment, encrypted user data can be processed, edited, or used in Block 514, FIG. 9B. The types of activities that can be performed in Block 514 include, but not limited to the following:

(1) Creating a web page using at least part of encrypted user's data and optionally newly added user data.

(2) Conducting data transformation before the data is used. Data transformation may include sorting, replacement of words and digital bits, rearrangement of words, extracting of special words, separating or splitting words, breaking up data pieces, changing file formats from a useless form to a useful form, creating a new form of data, etc.

(3) Conducting a search using user-provided keywords, against decrypted user data, getting a search result, and presenting the result on the client computer or using words in the usable data as search keys to search other data.

The responsive page may contain user's original data, transformed data, processed data, derivative data, or any combination thereof. Optionally, the user may review, process, and evaluate presented data on the client computer, write a summary, comment, statement or text, and upload the written data on the server and save them in a file or database as new data. Optionally, the new data may be encrypted by using the same encryption key or a different key.

### 2. Protecting Medical Records by Patients

Medical records might be needed in emergence cases. Thus, encryption by using patient keys should not affect patient emergence treatments.

Any part of online medical records may be encrypted by using patient keys per the first embodiment.

One preferred method is separating medical data into personal identity data, payment data, and medical records. The medical records can be identified by using a full person name with a unique code or text string for identifying the person. Birth date, social security number, payment information, and other personal information should not be entered into the body of medical records.

Personal account data and payment data may be shown in the user data Summary Table as in FIG. 8A. The data are encrypted by using the user's encryption key. When the user does not provide the encryption code, the server can generate a medical report with only person name and the unique number or string. The information should be generally enough for emergence use. Full personal identity, such as birth date, social security number, payment information, and optional personal health data will appear in a printed medical report only if the user has provided an encryption key to decrypt the user data. An initial setup may be made by an email link, a link by a health care, a phone call to urge the patient to log in to the user account, etc.

Similarly, the medical provider may use patient-provided credit card data for charging service fees, the health care provider should not save credit card data and necessary payment information in an online server that can be accessed by the public. For health care providers, there are several ways to deal with payment methods:

(1) Payment data is created and authorized by using the method disclosed in the first embodiment. The patient will control the transaction by using a user-provided encryption key. In addition, patient may designate other personal data as encrypted user data.

(2) Payment data is stored on a separate off-line computer which is not configured to have network access. Other sensitive data designated by the user may be encrypted and tracked as single or related entries. To avoid insider-assisted attack risk, such an off-line system should be configured to restrict accesses by using strict internal policies.

The purpose is reduce the inventive for hacking the whole database and alter the internet ecosystem. Weak security in some individual user accounts is not important.

3. Protecting credit report data by consumers

Credit agencies sell credit data mainly in two ways. They sell partial data to prospective merchants who need credit scores in selling their products. They also sell full credit reports to companies that need credit data in conducting business with consumers.

Any part of the credit report or the full report may be encrypted according to the first embodiment. Thus, such a credit report is not viewable without the authorization of the consumer.

A preferred method for safe protecting credit data is separating personal identity from the credit reporting data. Personal identity data are stored in one file or data tables while the full report is stored in another table. A report is associated with the right person by using a name plus a unique identification code, which might be a number, a string or a combination. Person's name and the identify code are stored as a usable form.

The consumer may choose to encrypt some or all personal identity data, the full report. The reporting agency keeps identity or identification data in the usable form on a computer system that is not directly accessible from the internet. The identity or identification data for use in production site is encrypted by using user-provided key. Credit report database contains redacted transaction entries, without personal identification data, credit card numbers, banking account numbers, and anything consumers might object. All personal information is redacted from the transaction histories.

Even if a consumer chooses to encrypt the identification data by using the functions shown in the User Data Summary Table, the agency can locate a related redacted credit data for the consumer.

If the consumer authorizes the agency to issue credit reports, the consumer enter this own key to decrypt protected user data. Personal identity data is processed and inserted into the full credit report.

4. Protecting banking data by users

Bank data breaches are very harmful to consumers because account information can be used to steel money. Personal identity data can be used to harm the consumers in many ways.

The bank can improve its financial transaction data by using the same principle stated in the invention. Since this class of data must be controlled by bank, the bank may need to use its own encryption key that is not stored on the system.

The consumer's user data can be protected in the same way. Banking data include (1) consumer's identity data such as social security number, birth day, email address, phone number, and addresses; (2) credit-related data including credit transactions, past dealings, past earning, etc.; (3) money receiving data that reflects money transfers from outsider sources; and (4) payment data that a consumer might have arranged to make payment by using credit card accounts, store accounts, patient accounts, etc. Most of the data can be encrypted by using a user-provided key shown in the User Data Summary Table.

Different types of data may be encrypted using different keys if they are used in different frequencies. The personal identity data may be used in connection with annual account review. The payment information may be used at daily, monthly, quarterly or yearly frequencies.

The bank may keep personal data in a system that is not connected to the Internet. To provide a method for solving identity disputes, the bank may need to maintain a central system that is off-line or contains encrypted identity data. In addressing a dispute, an employee can retrieve data from the system, and distribute found data to an investigative employee by secured email or messaging. The resolution system will not defeat the purpose of changing the internet ecosystem.

### 5. Protecting User Data in Automatic Transactions Between Two Persons

In this embodiment, user data is created and used for the benefit of anther person. For example, user A and user B may transact a business on a system controlled by a thirty party. The user A provides user data stored on the system for the user B's benefit; and optionally, the user B may provide user data for the user A's benefits. All data must be used in a usable form by the server in conducting business transaction. If transaction can be done in small time windows, encryption of all user data will reduce the incentive to hank the whole database controlled by a thirty party.

The system has two hybrid systems, each of which is similar to that discussed for the first embodiment. Each of the users may upload user data to the server, encrypt the data, and store the encrypted data on the server. Each of the users may authorize transactions by decrypting data. At least a piece of usable data from the encrypted data is used in conducting automatic transactions such as making a payment, charging fees, distributing funds, collecting interest, collecting service charges, generate web pages, delivering services, etc. The third party running the server may get direct or indirect benefits from supporting the transactions.

### 6. Protecting User Data in Manual Business Transactions

The method disclosed in the first embodiment may be used in conducting manual business transactions. User data is encrypted and stored in an unable form. When there is a need, the user provides an encryption key to the server, and the server decrypts the data to generate a usable data, saves the usable data on the server. The staff of the server will access the usable data, review the data, or process the data by using non-automatic method.

The user may designate a special time as the use period. After the business transaction is completed, the server will delete the usable data automatically, or after the transaction period is over, the user may choose to delete the usable data.

In one version of the embodiment, two persons share user data by saving them in encrypted forms. Each of persons may decrypt data to generate usable data, save the usable data on the server, designate time window for deletion. After the transaction is closed, the server will automatically delete the data or any of the users may use online tool to cause the server to delete the usable data.

The method disclosed in first embodiment may be useful in protecting user data in dating website. The data may be classified as public data and private user data. Personal data is normally stored in an encrypted form.

7. Protecting User Data that are Hosted on a Server

One embodiment is a general model for protecting user data belongs to other persons. This model is shown by using an example for the Online Computing System.

The original data input may be done by manually inputting and uploading files, database tables, field data, etc. This model shows how the users edit, change, and use data between the encryption-and-decryption cycles. This is based on a sophisticated balance between trust-and-distrust in the server.

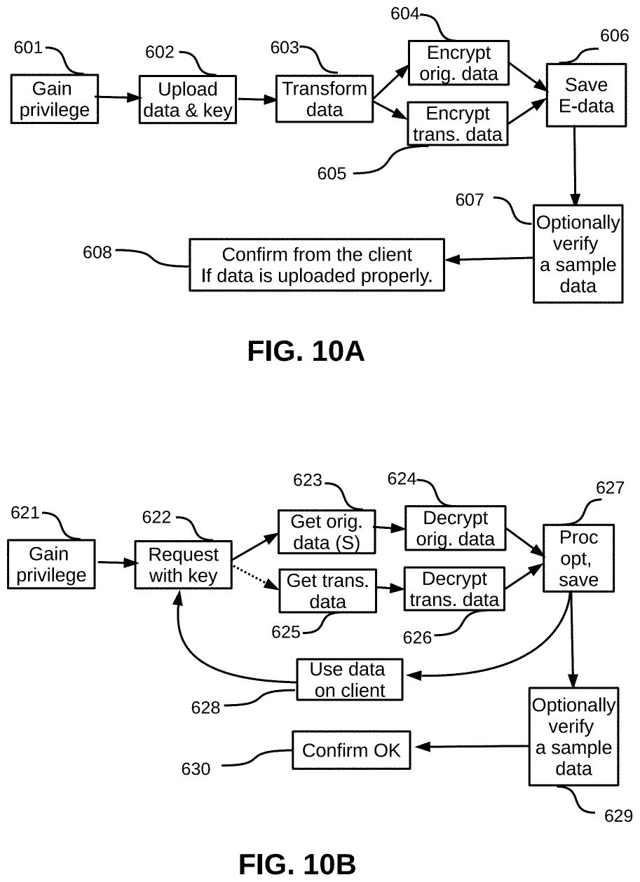

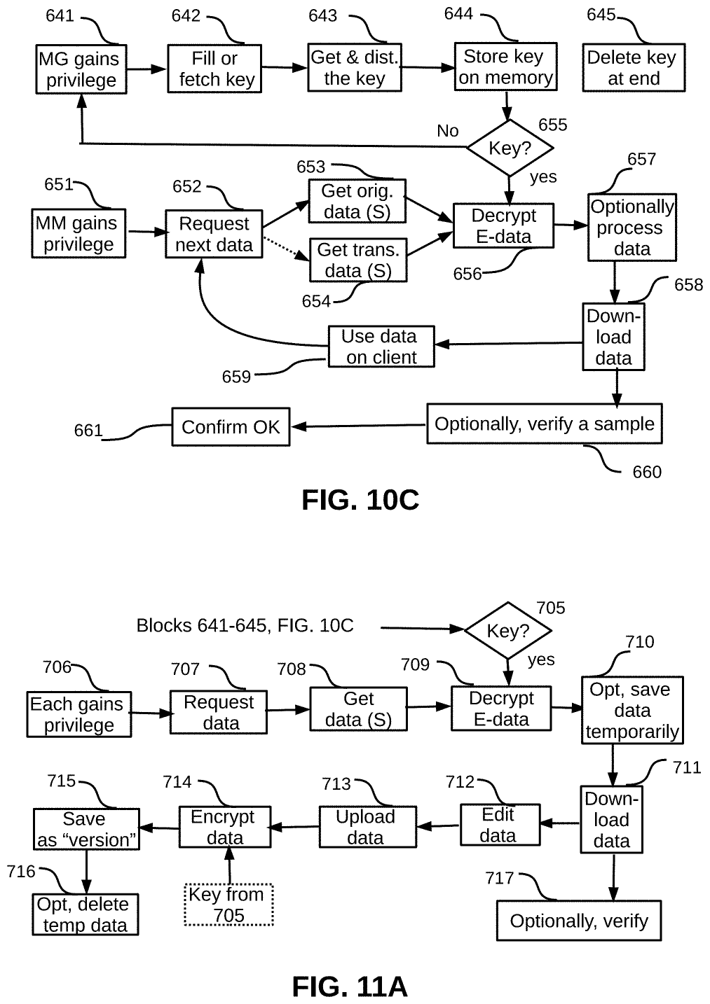

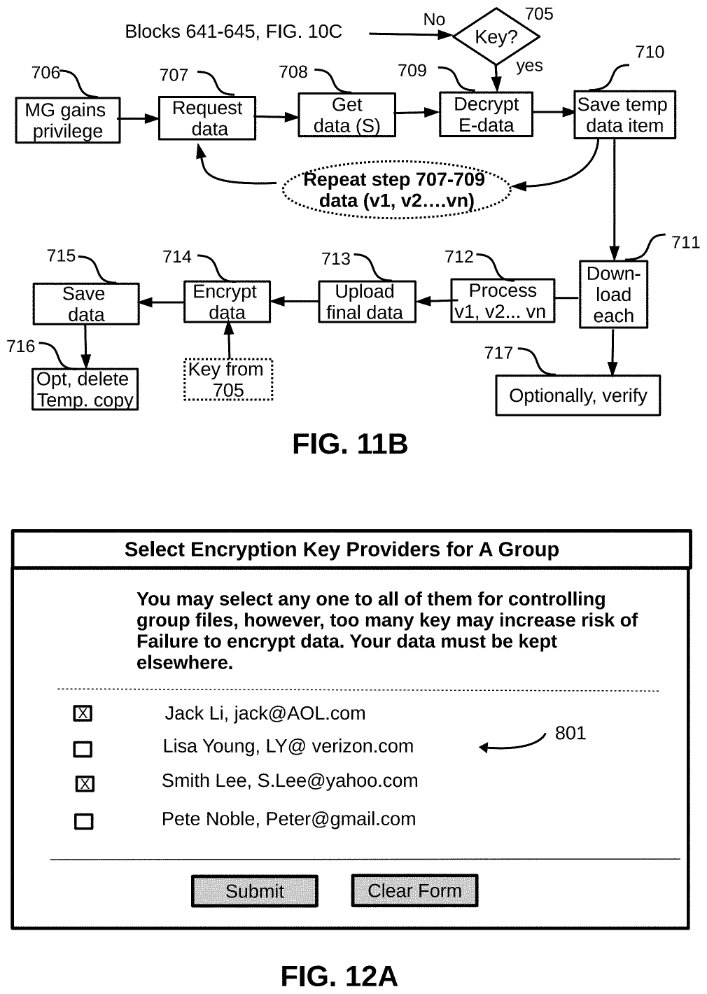

First, user data, other related data, etc. may be uploaded per the method described in FIG. 9A. Moreover, data may be transformed per Block 603 of FIG. 10A. In this transformation step, the server can create template files, creating a model web page or forms, extracting data set, processing documents, converting file formats, rearranging data elements, adding an index to data elements or a database table in a large file, etc. for later use.

FIG. 10A shows how the user data may be transformed to one different form of data in Block 603, and the transformed data is optionally encrypted in Block 605, and original data is encrypted in Block 604. In the use stage (shown in FIG. 10B), both encrypted original data and encrypted transformed data are decrypted by using the encryption key at Block 624 and 625. The resulted usable data is used in conducting computation to get a result in Block 627, the result may be optionally saved in Block 627, and downloaded to the client computer for the user in Block 628.

Second, both original and transformed data can be further processed after the data is encrypted in the transaction cycle. All possible operations discussed for Block 514 in FIG. 9B can be used in this embodiment.

The first embodiment can be used to increase computation data security. FIG. 9B can be modified as follows: the user submits encryption key with additional user data (containing variable values) to the server in Block 511, gets stored encrypted user data from Block 503, decrypts the encrypted data at Block 513, conducts a computation at Block 514, gets a computed result and adds user data to create a result page, deletes usable data in Block 515, and sends the result page to the user in Block 516.

Third, both original and transformed data can be saved as temporary data after they are decrypted per Block 627, FIG. 10B. Potential actions at this point include conducting searches, doing a computation, generating presentable web page, creating a table, doing any digital processing, etc. Optionally, processed results such as computational result may be saved here temporarily. The data may be saved as name-value pairs in a delimited string, text file, or other suitable formats. Original, transformed, or processed user data may be used to generate web pages (in a way similar to the way for creating the payment form). Digital data may be processed by a computer algorithm to remove noise, change sound characteristics, delete certain words or bits or change bits or characters).

Fourth, the user may create new data, edit existing data, or compile data that has been generated by the server (See Block 659 in FIG. 10C; Block 712 in FIGS. 11A-11B). Saving the data will allow a plurality of users to edit the user data so that each of the users can create summary data, and upload new data, and a managing user can combine all changes. The submitted data may be kept as unprotected data. It may be treated as new user data to change, supplement, or overwrite decrypted user data. The modified user data is then encrypted.

An alternative method is that edited data may bypass encryption-and-decryption cycles for specified times, and is then encrypted for safe-protection at the end of a work day or the end of a project.

Five, the request for sending an encryption key can carry additional data which can be saved as encrypted user data. The carried new data can be used in conducting business transaction in the Blocks 511-512 in FIG. 9B (See the amount in Block 306 in FIG. 7B).

The security benefits would depend upon two conditions: the temporary data should be deleted when work has been completed, and the encryption key is deleted within a reasonable time after all connections are lost or project becomes inactive. The encryption-decryption cycles make hacking rest data more difficult and remove the incentive to hack the whole database.

One unique component of this embodiment is that the stored encrypted data is used by the server or by another party when the data is in a decrypted state.

Other potential operations include the following:

(1) Transformation of data. For example, after the a text file is decrypted, the server is able to find certain keys, find and replace, or count the frequency of certain keys directly from the decrypted data. This operation is done when the user data is in a usable state.

(2) post-decryption processing. After the data is decrypted, the data is processed by the server by using the digital values or ASCI values. The most common processing methods include combining data pieces from different locations in a single file, from different fields of a table, or from different tables, breaking down data into multiple pieces, changing data formality or file types, extracting numeric values or certain keys, or any combination thereof.

(3) human edit, writing, and combining results per the process shown in Block 628 of FIG. 10B as long as those operations are done in reasonable time windows; and

(5) carrying new data in a request. New data carried in the request may be merged into the existing data by going through a decryption-and-encryption cycle.

Following example shows how this data protection model can be applied to Online Computing System.

The Online Computing System comprises the following steps. The user selects a project by conducting a search, provides data or a file containing data, and uploads an encryption key to decrypt the stored data to generate usable data. The usable data is then used by the computing program and the result is presented to the user on a client computer.

In the original computation system, there is no need to use encryption. Inputted data may contain all data which is required for conducting a computation. The computation program or algorithm can take constant values and variable values from the usable data in conducting computation. Inputted data contains only variable values, optionally data on the computing project, but no constant values. The user data is used to generate a full result report with user data. Upon completing the computation, the server gets a result. Nothing is saved on the server.

The system is modified to save input files and results files. Those files can be encrypted and saved on the system. An input file can be created by dumping project data right before doing a computation step in the Online Computing System. At this point, the system gets all constant values, user-provided variable values, and units. It has all required data including a project ID.

The inputted data contains constants, optionally data on the computing project, but no variable values. In conducting the computation, the user uploads an encryption key to the server, and decrypts the encrypted stored input data to invoke computation. The system then generates a computing data input form, prompting the user to enter variable values. Upon completing the computation, the server does a computation to get a result and writes the result in a file for rendering on the client computer. The server may also encrypt the result file and saves it for later use. All usable data is then deleted. The variable values are not saved.

In the alternative, a custom input file may be used as means for inputting data that the computing program needs. The file is saved on the server in an encrypted form. When running a computation using the input file, the user selects the input file on a request with an encryption key to the server, and the server decrypts the saved input file to convert it into usable data, loads the usable data in creating a computing data input form, and rendering the form on the client computer. The user optionally modifies or changes any data on the computing data input form, and submits the form to conduct a computation to get a new result. The server writes the new result as an appended text to the input file or a separate result file, and encrypts the input file or the result file. The server renders the result on the client computer. All input files and result files are stored in the encrypted form which cannot be hacked.

### 8. Protecting Database Field Data in Shared Database

The embodiment of the present invention can be used to protect any of database fields. One issue is improving search efficiency. In prior art, typical method is to store both the encrypted value and a one-way hash of the value. When the system seeks a specific value, it would seek the hash. The system can query efficiently, without having to decrypt every row to find the value sought. Another method is to just extract keywords to be stored for search purpose while no search will be performed actually on the encrypted data.

The method disclosed in the first embodiment can be used to manage database. The user may designate one or more fields as encrypted fields. If asymmetrical keys are used, both keys must be sent to the server for use. Both the keys are used by the server, but not saved on the server permanently.

In any operation on encrypted data fields, an appropriate key is used to encrypt and decrypt data. The user interface for accessing, adding or modifying encrypted data must contain the key, with optional new usable data. The method can be used in all known commercial database applications. The encryption/decryption key may be stored in volatile memory according to the method discussed in FIG. 10C (see Blocks 641-645).

### 9. Protecting Group Data by User's Encryption Key

In this embodiment, all data is owned by one person or an entity, but is shared or used by a group of users working for the user or the entity.

As shown in FIG. 11A, the user gains privilege in Block 706, makes a request in Block 707. The server gets data in Block 708, decrypts data to generate usable data in Block 709, and saves the usable data as temporary data in Block 710. The usable data is then downloaded in Block 711, viewed and edited in Block 712, uploaded in Block 713, encrypted in Block 714, and saved as a new version or as replacement of user data on the server in Block 715. All data in the temporary data is automatically deleted upon expiration of time, or upon the user's action on a user interface in Block 716. Since the key is maintained in Black 705 for the user data, a plurality of users can edit a document and save many document copies. The managing user can merge all changes into one final document, and then delete working copies of the document.

In one application situation, project data is used only in a usable form but is not changed. All data are uploaded and encrypted by using the same encryption key. In another situation, project data is transformed into other forms such as text files, HTML files, excel forms, database table, other file formats for applications like Word, Excel, and OfficeWrite and any suitable file formats as in Block 605 in FIG. 10A. Data transformation takes place before the user data is encrypted or after the data is decrypted. Since the data is viewed, reviewed, processed, or read by a group of users, carrying key is inconvenient. There are three major methods for managing encryption keys.

### (1) Managing Encryption Key

Encryption key carried in each request. If project activities are sporadic or project members work at different times and different locations, the encryption key may be entered in each request. To avoid finding key each time, the system may be configured with a function to get the key from the client computer. An alternative method is to read an encryption key stored in a designated key store, a folder, cookies, or a USB device. Designated folder may be a folder on the client computer or a folder in a USB drive. The device may include a card reader, USB fab, smart card scanner, future driver's license scanner, computer accessible security token, or other input devices. This user interface may provide an option to promote the user to select a folder or device so that a script program can access and get the encryption key.

Storing encryption key in a volatile memory. If data is used by one person or a group of persons in multiple transactions, the encryption key may be stored on volatile memory or global variable which is designated for a user account, a group's project, a server, intended project data in a data center, or a whole system.

The encryption key is first submitted to the server or fetched from a designated location on the client computer. If multiple servers running to process data for the project, the same key is copied to the volatile memory of each server or make the key available to all servers.

If the server is running on the internet in a perpetual non-stop time, what is critically important is reducing the key availability on the system. The key is made available only when there is a need. If the key is not used for a reasonable time, it disappears or deleted. When a hacker attempts to capture the key in transmission, the hacker will most probably miss it.

The encryption key may be stored in a session object declared for a user or the group or the project. As long as a member is connected to the server or any member is active, the key will be there for use. The key may be acquired from a received request from a first connection in which the server promotes the member to provide an encryption key. After the key is optionally verified to be good, the server will store the encryption key in a session object for the connection or a session object for the group or project. The session object is kept alive as long as a connection is alive or any member's connection is alive. The session object is killed when all connections are lost or after the last member of the group logs out. The key may be saved on a session object of a designated member as an alternative.

The server may provide a tool to allow a server's employee to see its existence, partial digital characters, or partial information without disclosing the full digital content. The whole key is not be visible to the server staff and not permanently saved on the server. If the key is corrupted or damaged, a best way to recover the key is for a user to submit a new encryption key, and the server will redistribute the key, if necessary. If the server is rebooted or stopped, the key on the server will disappear. The key cannot be recovered from any disk, saved application data, application logs, temporary data, etc.

Encryption key management tool. The tool may be used to manage the encryption key for a complex project. User data is stored in a remote server, and a plurality of users worked on client computers at the project site, and a large number of data items such as files are to be processed, it is preferable to use this method to manage the key on the server. The key is assigned, maintained and controlled by one of the users at the client site. The server may keep an acquired encryption key in volatile memory: an application global variable (e.g., in Java, it would be the public field in a global class in an application package), a variable for a group or project and a variable for a specific connection.

For example, public class Topkey {public static String key1; public static String key2; . . . .}. Now, Topkey.key1 can be used to assign value and access stored value. Different programming languages used in developing the system requires adherence to different conventions. What is important is that variables declared and used must be consistent with the intended application scope, and the encryption key cannot be used or accessed by unintended users, unintended applications and unauthorized users. The key management too may support various schemes such as one key for a project and one key for several projects. Multiple keys may be used to protect different folders, different sources of data, and even different projects owned by the same user.

In a fallback option, the encryption key may be temporarily stored in primary storage media on a server on the following conditions: (1) there is no tool for retrieving, viewing and storing it; (2) server employees cannot view the full digital value of the key but see only partial information on its existence and condition; and (3) it is deleted whenever the project is inactive or all connections for the group or project are lost. It is important that the key cannot be recovered from a stopped server, hard disks, other storage media when the server is stopped. However, a risk is that when the server abruptly malfunctions, the server may fail to delete the key, thus the key may be recoverable by server employees by a small chance.

For a system with perpetual connection to the internet, the first key-management method is the most secure.

### (2) Using Temporary Data

Saving usable data as temporary data is an option discussed in FIGS. 11A, 11B. This option is necessary for editing user data. Editing user data is possible only after the server has decrypted the data. Optionally, any of the members may download the user data as backups on the client media. Upon specified times, the user may encrypt edited data and delete the temporary usable data. This scheme can be used to edit documents by a plurality of users.

One example is shown in FIG. 11B. Each user logs in Block 706, sends a request for accessing user data in Block 707, gets encrypted data in Block 708, saves the first editable copy in a temporary storage space in Block 710, downloads a copy in Block 711, edits the downloaded data in Block 712, uploads edited data in Block 713, encrypts the edited data as a distinctive version in Block 714, and saves the distinctive version in Block 715. By using the same method to download all versions, a managing user can finally merge all changes (See “v1, v2 . . . vn” in 713 in FIG. 11B) into one file, encrypt the final file, with an option to encrypt all edited intermediate files or delete them.

The true security benefit of this method is not obvious. This method can reduce the population ratio to usable data to total stored data. The on-and-off-action has an effect of shortening data vulnerable residency times.

### (3) Protecting Large Project Data Among Account Users

All project members have similar user accounts on the server, the group data is stored on the server, and users can access and view the group data from their accounts. In this environment, some of the group data is encrypted, and can be used only in the time window when the data is in a decrypted state.

All five types of actions for editing and processing data: transformation of original data, post-decryption processing, post-decryption storage, human edit and writing, and adding new data in an uploading request can be used in each decryption-and-encryption cycle.

The work product may be encrypted by using the same or different encryption key. Since the work product is only copy, the user is prompted to make periodic backups. After the project is finished, the work product is decrypted by using the right key and resulted usable data is removed from the online system to an off-line system.

The thrust of the invention is avoiding saving the encryption key on a database and avoiding using the exactly same security method for all user accounts, resulting in a different internet ecosystem.

### 10. Protecting Group Data by Multiple Personal Keys

Another embodiment is that a group's data is controlled by at least two encryption keys that are controlled by different members. The data can be used only when all designated encryption keys are available to decrypt the data. The method is used in two situations: multiple users share user data in a shared account or a single system, and a project data is used by multiple account users.

### (1) Method for Generating an Encryption Key

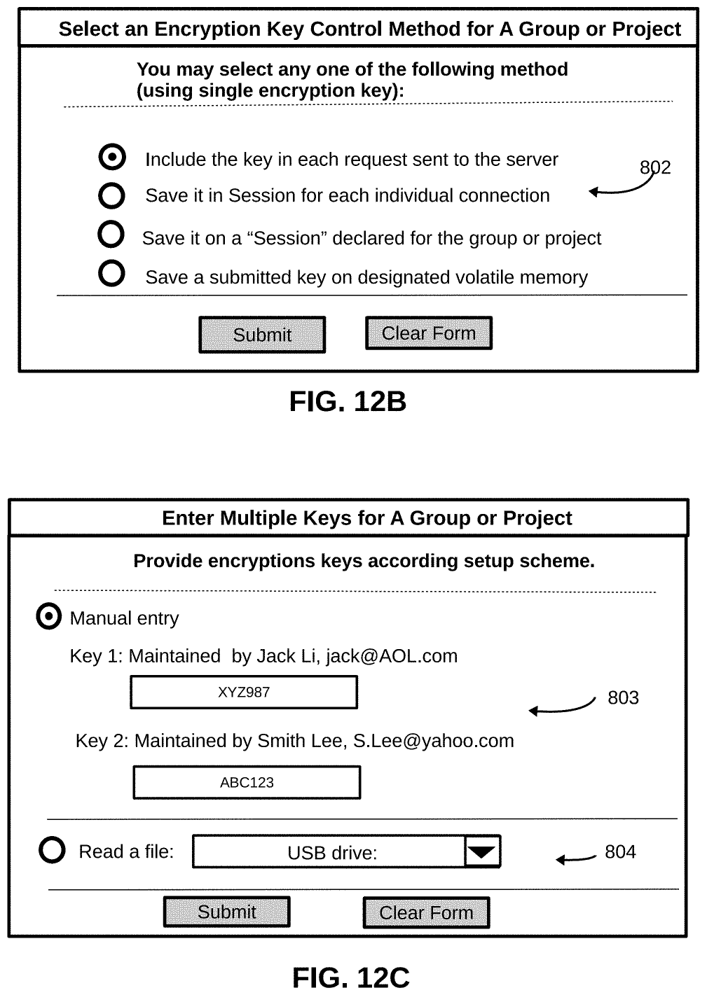

In this version of embodiment, the server supports a method for selecting a list of users who provides personal keys, as shown in FIG. 12A. This figure shows that the user may select any four members as key contributors. This embodiment supports a key-management method, as shown in FIG. 12B.

Personal keys are used to generate an encryption key which is used to encrypt and decrypt user or group data. The personal keys containing suitable characters or strings are properly combined by appending, logically XORing, or digitally mixing to form the encryption key. Digital mixing might include unique character combination, mixing digits of characters from different personal keys according to a predetermined pattern or scheme (e.g., all sequential odd digits is taken from one personal key, and all sequential event digits are taken from a second personal key), any reasonable scheme of mixing. The only requirement is that the method can generate only one unique encryption key. Suitable derivation functions may optionally be used to stretch the encryption key to increase the strength of the encryption key.

In the alternative, multiple encryptions may be used in lieu of using different keys. Data is encrypted by a first user's key, and resulted data is then encrypted again by using a second user's key. Decryption will be done in a reverse order.

### (2) Method for Generating an Encryption Key

In an environment involving multiple user accounts, an encryption key can be generated according to the following methods.

1. Upon a request, the server generates a user interface with web page and sends it to a managing user showing all user names as potential persons for providing personal encryption keys.

2. The new user designates the user accounts that will provide encryption keys.

3. Based upon the selection of the user, the server sends a user interface to each of designated users.

4. Each of the selected users responds by including a personal key to the server.

5. The server gets each personal key and saves it in a temporary file or data table. In each operation, it checks if all individual keys have been submitted.

6. The server will generate an encryption key by using all personal keys stored it in a temporary file or a database table according to a predetermined scheme.

7. The server deletes all personal keys from the temporary storage locations.

8. The resulted encryption key may be stored in a volatile memory, project session object, or global variable for the project or group. Key stretching is an option as long as it is used consistently.

Preferably, the server may conduct a verification test. The server prompts each of designated key providing users to provide his or her personal key. Each user may be presented with a hint as a reminder. The users will submit their keys in their own times. After all personal keys are submitted, an encryption key is constructed per the predetermined method. The server uses the encryption key to decrypt a saved user data piece or the verification data (which may using V-mart and a project password). After the verification is successful, the system is ready.

Upon finishing conducting business transactions, the server deletes all temporary user data, all personal keys (if any), and the encryption key on the server. Deletion may be done by system actions such as destruction of object, destroying of servlet, deallocation of memory, overwriting of digital values, or reusing the memory space for others purposes.

### (3) Running the Project by Using a One-Time Key

When the project is run, the server needs to encrypt data and decrypt data periodically. When the project starts, the server may construct the key in the following way:

1. The server sends email link asking each of the key-providing users to send his personal key within a specified time window;

2. Each of the users sends his or her key on a user interface with an optional key hint;

3. The server saves each submitted key on a temporary storage location such as a file or database table, and keeps determining if all required personal keys have been submitted;

4. After the server has received all personal keys, the server combines all personal keys per the predetermined method for creating the encryption key. Key stretching is optional;

5. The server saves the encryption key in a temporary location, and, as a best practice, deletes all personal keys.

6. The server performs all project functions by using the encryption key.

The project data can be used, processed, and/or edited only after the data has been decrypted when the original user data or transformed data are shown on a client computer. In addition, the work product of a user may be optionally encrypted by using the same encryption key or a different key (which can be generated by using the same method).

Whenever the project is inactive or the server is down, the encryption key will be gone, leaving the encrypted data in an unusable state. The method can reduce the risk of hacking. If the data is stored on the server for a very long time, all key providers are reminded that they must remember their personal keys. Project data should be backed up per preset reasonable schedules.

### (4) Modifications for a Group of Users Under a Single User Account

A group of users may share a user account so that all of the users can login to the account to access the user data or group data. The users are listed as group members preferably by using email address.

In creating the encryption key, the server first prompts a managing user to designate at least one to several users as key-providing users. The server then sends email to each of the designated users a message containing a link providing a key. Upon clicking the link, the server opens a page, prompting the user to provide a personal key according to predetermined specifications. The user provides a personal key on the page, and submits the page to the server. The server gets and saves the personal key on the server. Upon receiving each personal key, the server determines if all required personal keys have been submitted. Upon a finding that all personal keys have been received, the server generates an encryption key and uses the key to encrypt and decrypt user data. The server deletes all personal keys, and optionally save a hint for each personal key and essential information on how to regenerate the encryption key.

When there is a need to use encrypted group data, the initial request may be made by a user, a server scheduled action, or a server action triggered by a server or an employee action. The server uses the method to get personal keys from which it can regenerate the encryption key. It then uses the generated encryption key to encrypt and decrypt the group data.

The encryption key may be optionally saved in volatile memory for the group, a session object, or a global variable accessible to the group only. If the encryption key is saved in a database or file, it should be invisible to any users, and is deleted when the project is inactive, last user connection is lost, or the server is down.

### (5) Using a Single User Interface to Get Personal Keys

In one version of the embodiment, a single user interface is used to accept all encryption keys, as shown in FIG. 12C. The security benefits cannot be seen without understanding time effects of secrets, circumstantial changes, hacking incentives, and the whole system. This method is the most useful in dealing with wills and trusts. For example, one person, a settler, will create and store a file which is encrypted by using multiple personal keys. Those personal keys are then distributed to several persons. The data may be used to prevent disputes among those key holders in a future time. By the time when there is a need to decrypt the data, there is no need to keep secrets for the file. Using a single form for entering multiple personal keys is the most convenient. The encryption key is generated in the same way discussed above.

### 11. Protecting System Functions by a User Key

Server systems including a Versatile Information Management System disclosed in U.S. Pat. No. 10,069,892 B2 by Jianqing Wu implement functions for configuring a working environment for a user, a group, an account, or a system. Such a function allows a user on the client computer to change server configuration such as changing database table structures, setting up data sources for searching and data feeding functions, and changing account members, user information, and rights and obligations of the users. While those functions are highly desirable, they unfortunately create a risk that hackers may use the configurable tool to destroy the working environment, the accounts or the system.

A configuration function requires a configuration file, a program for executing the file and a command for call the program to run using the file. Thus, any of the configuration file, the program, or the invoking command can be encrypted by using a user encryption key that is not stored on the server. Without decrypting the file, it is impossible to run a configuration function. This method creates an ecosystem with a reduced hacking incentive.

This protective feature is realized in two steps. An encryption is performed on a configuration file, an executing program such as script, interpretative program or a compiled program, or an invoking command using the user encryption key to disable to the feature. One must make sure that the configuring feature will be disabled without causing an erratic default action. To run the configuring function, the user provides the encryption key to decrypt the file, the program or the command so that the server can run the configuring function.

### 12. Method for Changing the Encryption Key

The user may change the encryption key or keys to be used for a user, a project or group, a server, or a specified data store. The initial request may be made by a person on a client computer, or initiated by the server′ action of sending an email message containing a link for opening a user interface.

(1) The server generates a page embedded with the user identity, a program name to be called, and other necessary instructions for changing the encryption key. The page may contain a hint for the old encryption key;

(2) The user provides the old encryption key, and a new encryption key together with optionally a new hint for the new encryption key;

(3) Upon submission, the client computer submits the page to the server;

(4) The server retrieves the old encryption key, converts the old key into the usable key if the key has been used in a stretched form;

(5) The server retrieves encrypted data from the server; and

(6) The server decrypts the data using the old key, and encrypts the same data using the new key. The server calls steps 4 to 6 repeatedly, to change the encryption key for all data items.

The server may ask the user to verify if encryption has been done properly by conducting a verification test according to steps shown in FIG. 9F.

The key-changing form may optionally contain additional setup options for selecting the key location, search path for finding the key, and device that holds the key, and other options for the convenience of the users.

If the key is created by using multiple personal keys, the same method is used to create the old key and the new key. Both keys are saved in temporary locations for use.

### J. Further Modifications of the Invention

Encryption key may be any digital data such number, text, ASCI and even images, depending on the encryption algorithms used. The most preferable feature is that the encryption key for decrypting data cannot be recovered by those who designed the sever. If the user key is transferred into different form of information, the information is saved on the server, the data can be decrypted by using the stored information. However, the user's encryption is transformed into different by adding additional bits known to the employee running the server or to a third-party server, it will reduce the protective strength of this method. If user's key must be used to successfully construct the encryption key for decrypting user's data, the method has the highest security. If the workable encryption key can be constructed by a server program and third party's stored information, without the user's original key, the method will not have full protection. Its protective benefits come from reduced exposure from the plain view of personal data, inconvenience to access, and considerable more difficulties to acquire technical details for cracking all encryption keys for all user accounts. Moreover, the variations in using different tokens and bits and different construction methods make it more difficulty to hack all encryption keys that can decrypt user data, they can still be effectively eliminate the incentives to hack the user data database. If encryption is performed on the server, the key is deleted affirmatively, discarded by server system's action, serverlet's action, web application, or other programs developed for this system.

Increase Data Security. To further improve data transmission security, following rules are followed: (1) Eliminating all unnecessary middlemen from the security measure; (2) using the best security methods for improving data transport layer security; (3) reducing data vulnerable residency time on the server to the minimum; and (4) using diverse encryption algorithms, key-stretching methods, and different keys to increase data transmission security. Data transport security can be improved by using protocol, security designs of operation system and application, masking of user identity information, and use of transmission encryption. Transmission security may be improved by using HTTP secure (HTTPS) with transport layer security (TLS), secure sockets layer (SSL), using encrypted channels of communication, use of SFTP or Secure File Transfer Protocol, etc. In some cases, key stretching, key hashing, etc. may be used.

System environment. All embodiments may be developed by using any one or combination of suitable languages. The system of the present invention may be implemented on a Windows, Mac, Linux, and Unix Platforms. If the system may depend on any kinds of existing browsers or future-developed browsers. Internet protocol may be any kinds as long as they can support data transmission.

Data vulnerability time length. For some transactions such as payment, computation, and solving a problem, the data may exist in the vulnerable state only in one to a few seconds. If the user data is used in a human review, it might take one hour to several days. It is desirable to finish the review in the shortest times. For a very complexity transaction, user data may be moved onto a computer that is not configured to accept any communications from the internet. In such a system and firewall should be used, all unused ports should be closed.

Encryption Key. For all versions of embodiment, user's encryption key may be entered on a user interface page, fetched from a folder location or a device location on the client computer or any other secured cloud places. When the user interface is implemented by using a browser, the key may be stored on cookies. In situation where the client computer like a cellular phone is controlled by the user, an automatic-key retrieving method may be used to get the key from the client computer. The other method is that the server will use a program to find and get the key according to preset key location and search order. Search order may be set up and stored in the user account. The encryption key may be stored in a designated key store, a folder, cookies or device. If an encryption key is stored in a USB device, one may need to use a Web USB API or the device's native application for access. Many devices including card reader, scanner may also use USB port. USB square credit card, driver license, security token, fab, etc. may be modified to contain an encryption key. Future driver's license may contain user-writable data. Security tokens may store encryption keys. Credit card keypad or similar devices may be used by users to enter PIN or generate encryption keys. Special designs include a USB connector, RFID functions or Bluetooth wireless interface to enable transfer of a generated key to a client computer or the connected server. An encryption key for encrypting user's data may be encrypted by using a shared secret key, shared password, public key encryption method, hashing function, etc. to improve encryption keys safety during transmission between the client computer and the server. If encryption key may be improved by stretching method such as a hashing function or a block cipher. Key stretching may be used at the client computer or the server. Since the encryption keys are not stored on the server, key hints may be used as a reminder of the key on the user interface prompting the user to provide an encryption key.

Encryption algorithms. Due to the way of use in the invention, symmetrical encryption algorithms are preferred. If an asymmetrical encryption algorithm is used, the user needs a proper tool to generate both an encryption key and a decryption key. Encryption application is executed on the server using user's encryption key to encrypt data. The encryption application may employ various cryptographic algorithms such as public-key cryptography, symmetric-key cryptography, hashing, etc. Encryption algorithms include AES, twofish, Blowfish, serpent, DES, CASTS, IDEA, and MD5 with different strength. The encryption application may correspond to any available application, library, or module such as ACE, Botan, Bouncy Castle, CryptoComply, Crypto++, GnuTLS, Libgcrypt, Libsodium, Libtomcrypt, NaCL, Nettle, Network Secruity Service, OpenSSL, SafeZone FIPS Lib, WolfCcrypt, GNU Privacy Guard (GnuPG), Pretty Good Privacy (PGP.RTM.) and so on. Most encryption modes may be used, including electronic code book (ECB), Cipher Block Chaining (CBC), Cipher Feedback (CFB), Output Feedback (OFB), Counter (CTR), Galois/Counter [symbol] ode (GC [symbol] , authenticated encryption (CCM, OCB, CWC, EAX, IAPM and OCB), ciphertext stealing mode (CTS). XEX-based tweaked-codebook mode with ciphertext stealing (XTS), Advanced Encryption Standard Key Wrap Algorithm (AES-Wrap), and Stream Cipher (Stream). It is desirable to create a more chaotic data storage system, where different pieces of user data are encrypted by using different keys and different algorithms. Account user may choose private encryption algorithms. Users may select different encryption algorithms and may even select different algorithms for different data piece within the user accounts. The server application may use a global variable for storing a list of encryption algorithms and allow user to select a global encryption algorithm for different encryption needs. If the system allows a user to select different encryption algorithms to encrypt different pieces of data, the algorithm name or address must be saved on a specific data fields in setups.

User data storage locations. Since user data is encrypted, users' data may be stored on the user's client computer, user's cellular phone, a single server, and even several servers. When the user's data is not stored on a the server conducting business transaction, in conducting the business transaction, the server gets required data from the user's phone or third-party server and decrypt the data on the server before conducting the transaction. Data may be stored in different servers but such storage may increase the risk of data loss.

The servers and clients network. In each of the arrangements, business transaction is conducted on a server, several connected servers, or a server farm or multiple server farms. All tasks by one single server may be performed by a plurality of servers that are connected. Thus, a server may include any of the servers as long as they work together to perform the function for intended purposes. The client computer may also be a server as long as it can perform the required functions of a server. A server may also be a client computer as long as it can perform like a client. A client computer may be any of computers connected to the internet or a private network.

Client encryption and server encryption. Default encryption machine may be designed by using a setup program. The setup data may be used under the account. Encryption of data may be performed on a client computer or the server, the task will need more steps. When encryption is performed on a client computer, user data is encrypted first and then is uploaded and stored on the server. If server is set up to perform encryption/decryption, the server always needs to get the encryption key from the user client computer or the user's designated location. Client encryption and server encryption are exchangeable in function. The main purpose of sending encrypted data with accompany key is not address transmission security, but to reduce the risk of exposure in the short time widows in which data is used. It also eliminate the plain view of any sensitive data. How, transmission security should be achieved by any known prior art technologies. In authorizing a business transaction, encrypted user data is downloaded to the client computer, decrypted on the client computer by using a user-provided key to generate usable data, and then send the usable data back to the server. If encryption of data storage security is performed on the server, the client computer must upload the key to the server for decrypting the data and proceed the rest actions as usual. Both server encryption and client encryption methods can be used. Details are disclosed in U.S. Pat. No. 9,449,183.

If the user interface in the client computer is implemented by using a browser, the encryption algorithm may be installed as plugins in the browser. One example is Rijndael Encryption Algorithm JavaScript published in 2001 and modified versions. Browser developers can add more methods for encrypting data. To encrypt any field data on a browser, the encryption function may be triggered by a user action. Encryption algorithms may be downloaded from the server to the browser of a client computer which can be called by a script. After the user sets up the system with client-side encryption, the browser uses selected encryption algorithm and the user-provided key to encrypt user's data on the client computer.

User accounts. In most business systems, user accounts are used. Account is necessary when multiple users share server resources in conducting business transactions, using system resources for the benefits of the user, and transacting business with other users. Account is not necessary when a server provides services to public members. In authorization step, log-in is optional. The program is configured to check a transaction identity information such as a hashed code to know the scheduled transaction so that there is no need to validate the user's identity such as log in name and password. However, the server may promote the user to log in the user's account to initiate a transaction. The sever may remember the page by directly open this page upon the user's logging in. When a transaction is authorized by email or instant message, the validation is by email sender address or phone number, and transaction identity, etc.

Access code may be used if user data is shown with other account user to avoid sending data to a wrong recipient account. An access code may be implemented using a fixed number of characters for authentication purpose.

When user account is used, some inherent functions include changing the account password, changing personal profile, recovering password, and resetting password. Additionally, challenges and questions dialog may be used to ascertain personal identity in the event that a user wants to recover account password.

Access user's data by links. If it is required to share encrypted data with an authorized person in some situations, the data may be shared by using global sharing function. The encrypted data is first decrypted and usable data is stored in a text file or native file in a temporary storage location. A link is created, which can invoke a download program for downloading the file or accessing the data and is sent to the email address of the intended recipient. The recipient clicks on the link which causes the server to download the file or retrieve the data. The file or data will be deleted as soon as it has been shared, downloaded or read. In an alternative, the usable data to be shared may be encrypted by using a temporary key that can be given to the recipient. When the recipient clicks the link, the server prompts the recipient to provide the temporary encryption key. The server decrypts the file or data and downloads the file or data to the client computer.

Use database in the embodiment. All versions of embodiment can be realized by using custom-developed database, commercial database, and even a file when there is only a limited number of records in a person's cellular phone. On the setup page, the user may be warned that the user should delete the encryption key if the client computer is a public computer. Optionally, the server can use the session identity to send a page with Javascript code for deleting the encryption key in a public computer before the session expires. This deletion action may be triggered by time. The browser needs to call a plug-in component for deleting the key if the key is saved on a removable storage media on the client computer.

In those exemplary and preferred embodiments of the present invention, specific components, hardware parts, arrangements, and processes are used to describe the invention. Obvious changes, modifications, and substitutions may be made by those skilled in the art to achieve the same purpose of the invention. The exemplary embodiments are, of course, merely examples and are not intended to limit the scope of the invention. It is intended that the present invention include all other embodiments that are within the scope of the claims and their equivalents.

What is claimed is:

1. A system for facilitating a user to conduct business transactions with one or more servers connected in a network or the Internet, the personal system comprising:
a client computer configured to host transaction data for tracking user data, render on its display one or more screens of user interfaces for receiving data from the user and interacting with the server, and optionally have an encryption tool for encrypting and/or decrypting user data by using a user-provided encryption key;
a server configured to receive user data in an encrypted form from the the client computer and optionally store the encrypted user data on the server;
at least one storage component configured on the client computer, the server, a connected computer or their combinations for storing transaction data for at least one business transaction, the data for each business transaction containing encrypted user data, optional encryption information, server connection information, and information for making the business transaction;
a transaction management component of the user computer configured to retrieve transaction data from the at least one storage component, use the retrieved transaction data to construct at least one business transaction, render the at least one business transaction on the user interface as a user selectable menu, and, upon user selection, provide a user interface for making an authorization to complete the selected business transaction;
an authorization component configured to retrieve the encrypted user data from the at least one storage component, decrypt the retrieved user data on the client computer or the server by using an encryption key provided by the user to produce usable data, and uses the usable data to process a business transaction,
wherein the process of making an authorization for the selected business transaction further comprises the steps of receiving an encryption key from user's input or a designated memory location, sending the encryption key together with information for the business transaction to the server, retrieving encrypted user data from the server, decrypting the encrypted user data to produce usable data, and complete the business transaction on the server or another connected processing server, or comprises alternative steps of receiving an encryption key from user's input or a designated memory location, getting encrypted user data from the the client computer or another connected computer, decrypting encrypted user data using the encryption key on the client computer or a connected computer, sending usable data to the server, and completing the business transaction on the server or a connected processing server without saving the usable data; and
an acknowledgment component on the server or the connected processing server sending an acknowledgment as a responsive message on the user interface for making authorization, as an email to the user's email address or as an instant message to the user's phone number.

2. A system of claim 1, further comprising a feature of uploading data from the system to a server in the setting up a new business transaction, wherein the uploading step further comprises the steps of generating a user interface for uploading data together with an encryption key, uploading data with an encryption key to the server, encrypting the part or all of uploaded data on the server by using the accompanied encryption key, and saving the uploaded and encrypted data on the server, or alternative steps of generating a user interface for uploading processing data, encrypting user's data using a user-provided key or a key from the system on the system, uploading encrypted data to the server and saving the encrypted user data on the server for future use.

3. The system of claim 1, wherein the business transaction is making a payment, accessing bank records, accessing credit reports, accessing medical records, accessing personal information, conducting computation, accessing data in database, and conducting a computation job.

4. The system of claim 1, further comprising feature of including new data in the user interface for making the authorization whereby a user provided data is used to replace, amend, or supplement existing data which is resulted from decrypting the encrypted data on the server so that the new data can alter the business transaction.

5. The system of claim 1, further comprising a feature of designating the encryption key location on the client computer or search order for searching the key whereby the encryption key is found in the designated key location or by searching the key in the search order on the client computer.

6. The system of claim 1 further comprising a feature of saving the encryption key only on volatile memory on the server for repeated uses wherein the encryption key disappears upon shutting down the server or is deleted after the user's connection is terminated.

7. The system of claim 1 further comprising a feature of making an authorization by using an active voice connection, wherein the system has the capability of detecting a user's request or a server request for sending inaudible user data over to the server, and, upon user input, sending a user-provided encryption key to the server, wherein the server retrieves stored encrypted user data, decrypt the retrieved data to produce usable data, uses the usable data to complete the transaction on the server or a connected processing server, and send an acknowledgment to the system by voice, rendered text on the user interface, instant message, or email.

8. The system of claim 1, wherein one of the choices of business transactions in the user interface is for issuing a digital check on a banking account or a two-way credit card account by submitting a payment instruction upon successful decrypting an encrypted mark stored on the server by a user-provided encryption key, or creating an image check and sending it to the acquiring bank's server which sends the image check to the issue bank's server where the check is validated by comparing its digital content with that of the image check that has been resulted from decrypting the encrypted image check stored on the server of the issue bank.

9. A method for conducting business transactions using a system comprising at least one server and at least one client computer in a network or the Internet, the method comprising the steps of:
creating a plurality of data records on the client computer for conducting business transactions;
providing on the client computer a user interface showing at least one business transaction;
uploading user data, wherein the uploading step comprises generating a user interface for uploading data with an encryption key, uploading user-provided data with an encryption key to the server, encrypting at least part of the data on the server by using the encryption key, and saving the uploaded and encrypted data on the server, or comprises generating a user interface for uploading data, encrypt the data on the client computer, and uploading the encrypted data to the server, and storing the encrypted data on the server, wherein the data encrypted by using different encryption keys are stored in the same database or related databases on the servers;
authorizing a business transaction from a client computer, wherein the authorizing step comprises generating a user interface for uploading an encryption key together with the information identifying the business transaction to the server, rendering the user interface on a client computer for the user, getting a user-provided encryption key or getting an encryption key from the client computer, sending the encryption key with the information identifying the business transaction to the server, retrieving saved encrypted data for the business transaction, and decrypting the retrieved data with the uploaded encryption key on the server to generate usable data, or comprises generating a user interface for downloading encrypted data to the client computer, decrypting the downloaded data using user-provided key, uploading the resulted usable data to the server, and validating the usable data on the server;
conducting a business transaction, wherein the step of conducting the business transaction further comprises getting usable data, using the usable data to conduct a business transaction on the same server or sending the usable data to a remote server to complete the transaction, generating user interface for informing the result of the transaction, and rendering the result on the client computer.

10. The method of claim 9 wherein the business transaction is making a payment, accessing bank records, accessing credit reports, accessing medical records, accessing personal information, conducting computation, and accessing data in a database.

11. The method of claim 9 wherein the business transaction is making an inaudible payment over a phone call-in-progress over an active voice connection.

12. The method of claim 9 wherein one of scheduled business transactions is writing a digital check, wherein the uploaded user's data is an image check, the authorization step further comprising issuing an image check drawing from a banking account or a two-way credit card account, submitting the image check to the server of the issue bank of the account or server of the acquiring bank of the payee, and validating the imaging check by comparing the digital content of the issued image check against the digital content generated from decrypting the image check stored on the server by a user-provided encryption key.

13. The method of claim 9 wherein the uploaded user's data is an encryption mark with one copy of which is encrypted by using user encryption key and one copy of which is encrypted by using an account password, the authorization step further comprising issuing a text check by sending a payment instruction to the server of the issue bank upon determination that user has provided a correct encryption key, sending from the issue bank a message asking the user to approve the payment, and receiving a message approving the payment by the user.

14. The method of claim 9 further comprising steps of accepting an hint for the encryption key in the user interface for uploading user's data, saving the hint on the server, and displaying the hint in the user interface for the transaction-authorizing or include the hint in an email prompt the user to authorize the business transaction.

15. The method of claim 9, further comprising a step of including new data in the authorizing step, wherein the new data is used to replace, amend, or supplement existing data so that the new data alters the business transaction done in the business transaction step.

16. The method of claim 9 wherein the encryption key is gotten from the location designated by the user in the uploading step.

17. A method for protecting user data stored in a database on a system comprising at least one server and at least one client computer in a network or the Internet, the method comprising:
creating a plurality of data records on the client computer for conducting business transactions;
providing in the client computer a user interface for showing at least one business transaction;
creating a plurality of user accounts on the server for conducting at business transaction which is of a type selected from the group consisting of processing a payment, conducting a search, combining data pieces or breaking down data into multiple pieces, and extracting numeric or ASCII values;
creating a secured merchant database by each of a plurality of users in the steps of generating a user interface for uploading data with an encryption key, uploading user-provided data with an encryption key to the server, encrypting the data on the server by using the encryption key, and saving the uploaded and encrypted data on the server, or in the alternative steps of generating a user interface for uploading data, encrypt the data on the client computer, and uploading the encrypted data to the server, and storing the encrypted data on the server, wherein the data encrypted by using different encryption keys are stored in the same database or related databases on the servers;
authorizing business transaction by each of the plurality of users by the steps of generating a user interface for uploading an encryption key with data identifying a unique business transaction, rendering the user interface on a client computer for the user, sending the encryption key with information identifying a business transaction to the server, retrieving encrypted data for the transaction from the server, decrypting the encrypted data with the uploaded encryption key on the server to generate usable data, or by alternative steps of generating a user interface for downloading encrypted data to the client computer, decrypting the data using a user-provided encryption key on the client computer, uploading the decrypted data to the server as usable data,
wherein, in response to each business transaction, the server uses the usable data to conduct the business transaction, and wherein data in the plurality of user accounts are encrypted using user-provided different encryption keys, which are not permanently saved on the server.

18. The method of claim 17, further comprising a step of selecting data items to be encrypted and stored in the database in a setup page or a step of changing items to be encrypted.

19. The method of claim 17, further comprising a step for processing and transforming data, saving the transformed data on the server for the user, and using usable transformed data and/or original data in conducting a business transaction.

20. The method of claim 17 wherein the transformed data, original data, and/or newly uploaded data are used in conducting a business transaction.
